(19) United States
(12) Patent Application Publication
(10) Pub. No.: US 2018/0225324 A1
(43) Pub. Date: Aug. 9, 2018

(54) Providing Retry Schedules For File Repair Over Broadcast Networks

(71) Applicant: QUALCOMM Incorporated, San Diego, CA (US)

(72) Inventors: Carlos Marcelo Dias Pazos, Carlsbad, CA (US); Nagaraju Naik, San Diego, CA (US)

(21) Appl. No.: 15/867,310

(22) Filed: Jan. 10, 2018

Related U.S. Application Data
(60) Provisional application No. 62/454,982, filed on Feb. 6, 2017.

(51) Int. Cl. G06F 17/30

(52) U.S. Cl. CPC G06F 17/30371; H04W 4/06

(57) ABSTRACT

Various embodiments include methods, user equipment, and a computer program product for determining multiple retry schedules for performing file repair procedures for repairing files received over broadcast networks (e.g., evolved Multimedia Broadcast Multicast Services (eMBMS)). The user equipment may receive an information element that identifies parameters defining additional timelines for performing file repair. The user equipment may perform file repair based on the additional timelines.

### RELATED APPLICATIONS

This application claims the benefit of priority to U.S. Provisional Application No. 62/454,982 entitled “Providing Retry Schedules For File Repair Over Broadcast Networks” filed Feb. 6, 2017, the entire contents of which are hereby incorporated by reference.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

Hypertext Transfer Protocol (HTTP) streaming is currently the most popular method of delivering content over the Internet. For live events, content is made available progressively through constant duration segments. The segment availability follows a timeline that indicates when each successive segment becomes available at the HTTP server.

Dynamic Adaptive Streaming Over Hypertext Transfer Protocol (DASH) is a standard that implements HTTP streaming. DASH announces the segment availability in a Media Presentation Description (MPD). The MPD defines a segment availability timeline that announces the defined segments and the times when segments are available for HTTP access.

### SUMMARY

Systems, methods, and devices of various embodiments enable signaling information in evolved Multimedia Broadcast Multicast Service (eMBMS) broadcasts that enables user equipment to obtain file correction information via unicast if an initial availability of such information over broadcast was missed or partially received. Various embodiments include methods that may be implemented in a processor or processing devices for receiving a file by a user equipment that may include determining whether a file repair procedure of the file was successfully performed during a first window of time specified in a broadcast schedule description, and in response to determining that the file repair procedure of the file was not successfully performed during the first window of time, determining a second window of time for attempting an additional file repair procedure based on an Associated Delivery Procedure Description (ADPD) fragment in the broadcast schedule description or a File Delivery Template (FDT) fragment in the broadcast schedule description, and attempting the file repair procedure during the determined second window of time.

In some embodiments, determining a second window of time for attempting an additional file repair procedure based on an ADPD fragment in the broadcast schedule description or a FDT fragment in the broadcast schedule description may include determining a second window of time for attempting file repair procedure based on an ADPD fragment in the broadcast schedule description. In some embodiments, the ADPD fragment may include a window start attribute, a random period attribute, a repeat interval attribute, a stop interval attribute, and a number of times attribute.

Some embodiments may further include attempting the file repair procedure at a time based on the window start attribute, the repeat interval attribute, and a random offset amount of time based on the random period attribute.

Some embodiments may further include determining whether the file repair procedure during the determined second window of time was successful, and in response to determining that the file repair procedure during the determined second window of time was not successful, determining a third window of time for attempting an additional file repair procedure based on the repeat interval attribute and the stop interval attribute in the ADPD fragment and attempting the file repair procedure during the determined third window of time.

In some embodiments, determining a second window of time for attempting an additional file repair procedure based on an ADPD fragment in the broadcast schedule description or a FDT fragment in the broadcast schedule description may include determining a second window of time for attempting file repair procedure based on an ADPD fragment in the broadcast schedule description. In some embodiments, the ADPD fragment may include an offset time attribute, a random time period attribute, and a number of times attributes.

Some embodiments may further include attempting the file repair procedure at a time based on the offset time attribute offset by a random amount of time based on the random time period attribute.

Some embodiments may further include determining whether the file repair procedure during the determined second window of time was successful, and in response to determining that the file repair procedure during the determined second window of time was not successful, determining a third window of time for attempting an additional file repair procedure based on the offset time attribute and a random amount of time based on the random time period attribute.

In some embodiments, determining a second window of time for attempting an additional file repair procedure based on an ADPD fragment in the broadcast schedule description or a FDT fragment in the broadcast schedule description may include determining a second window of time for attempting file repair procedure based on a FDT fragment in the broadcast schedule description. In some embodiments, the FDT fragment includes a retry time attribute and a random period attribute.

Some embodiments may further include attempting the file repair procedure at a time indicated by the retry time attribute and a random offset amount of time based on the random period attribute.

Some embodiments may further include repeatedly attempting the file repair procedure during intervals of time defined by the retry time attribute and a random offset amount of time based on the random period attribute until the file repair procedure is successful.

Various embodiments may include a user equipment for wireless communication including a processor configured with processor executable instructions to perform operations of any of the methods summarized above. Various embodiments may include a user equipment for wireless communication having means for performing functions of any of the methods summarized above. Various embodiments may include a non-transitory processor-readable medium on which is stored processor-executable instructions configured to cause a processor of a user equipment to perform operations of any of the methods summarized above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a diagram illustrating an example of a network architecture suitable for use with various embodiments.

FIG. 1B is a diagram illustrating an example of a user device suitable for use with various embodiments.

FIG. 2 is a diagram illustrating an example of an access network suitable for use with various embodiments.

FIG. 3 is a diagram illustrating an example of a downlink (DL) frame structure in LTE.

FIG. 4 is a diagram illustrating an example of an uplink (UL) frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia Broadcast Multicast Service channel configuration in a Multicast Broadcast Single Frequency Network.

FIG. 7B is a diagram illustrating a format of a Multicast Channel Scheduling Information (MSI) Media Access Control (MAC) control element.

FIG. 8 is a diagram illustrating an example of a session schedule including file schedules within the session.

FIG. 9 is a graphical illustration of the XML schema of a session schedule description fragment.

FIG. 10 is a graphical illustration of the XML schema of a session schedule description fragment including a FDT location URI attribute.

FIG. 11 is a graphical illustration of the XML schema of a session schedule description fragment.

FIG. 12 is a graphical illustration of the XML schema of a file schedule description fragment including an alternative-content-location attribute and an availability-time attribute.

FIG. 13 is a graphical illustration of the XML schema of an Associated Delivery Procedure Description (ADPD) fragment extension providing one or more additional file repair time window(s) according to various embodiments.

FIG. 14 is a diagram illustrating an example of a timeline for one or more additional file repair time window(s) according to various embodiments.

FIG. 15 is a graphical illustration of the XML schema of an alternate ADPD fragment extension providing one or more additional file repair time window(s).

FIG. 16 is a diagram illustrating an example of an alternate timeline for one or more additional file repair time window(s).

FIG. 17 is a graphical illustration of the XML schema of a File Delivery Template (FDT) fragment extension providing one or more additional file repair time window(s).

FIG. 18 is a diagram illustrating an example of an alternate timeline for one or more additional file repair time window(s).

FIG. 19 is a diagram illustrating an example of a general timeline for file repair.

FIG. 20 is a conceptual data flow diagram illustrating the data flow between different modules and components in a receiver device suitable for use with various embodiments.

FIG. 21 is a process flow diagram illustrating a method of recovering a file according to various embodiments.

FIG. 22 is a diagram illustrating an example of a hardware implementation for an apparatus employing a processing system.

FIG. 23 is a component diagram of an example mobile device suitable for use with various embodiments.

FIG. 24 is a component diagram of an example server suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various embodiments include methods for signaling information in evolved Multimedia Broadcast Multicast Service (eMBMS) broadcasts that enables user equipment to obtain file correction information via unicast if an initial availability of such information over broadcast was missed or partially received.

The word “exemplary” is used herein to mean “serving as an example, instance, or illustration.” Any implementation described herein as “exemplary” is not necessarily to be construed as preferred or advantageous over other implementations.

As used herein, the terms “a user equipment” (UE) and “receiver device” are used interchangeably herein to refer to any one or all of cellular telephones, smart phones, personal or mobile multi-media players, personal data assistants (PDA's), laptop computers, tablet computers, smart books, palm-top computers, wireless electronic mail receivers, multimedia Internet enabled cellular telephones, wireless gaming controllers, smart televisions, set-top boxes, digital video recorders (DVRs) and similar personal electronic devices which include a programmable processor and memory and circuitry for receiving an MPD and making the MPD available to a DASH client.

DASH is a standard that implements HTTP streaming. DASH announces the segment availability in a MPD. The MPD defines a segment availability timeline that announces the defined segments and the times when segments are available for HTTP access. In current systems, the MPD is provided to a receiver device via OTA delivery. The Third Generation Partnership Project (3GPP) has standardized DASH over Download Delivery as a method to be used for providing HTTP streaming using broadcast over Long Term Evolution (LTE) (i.e., eMBMS).

Various examples of different applications/clients, middleware, segment availability timelines, radio technologies, and transport protocols are discussed herein, specifically DASH clients, Multicast Service Device Clients (MSDCs), MPDs, eMBMS, and HTTP. The discussions of DASH clients, Multicast Service Device Clients, MPDs, eMBMS, and HTTP are provided merely as examples to better illustrate the aspects of the various embodiments, and are not intended to limit the various embodiments in any way. Other applications/clients, middleware, segment availability timelines, radio technologies, and transport protocols may be used with the various embodiments, and the other applications/clients, middleware, segment availability timelines, radio technologies, and transport protocols may be substituted in the various examples without departing from the scope of the claims.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

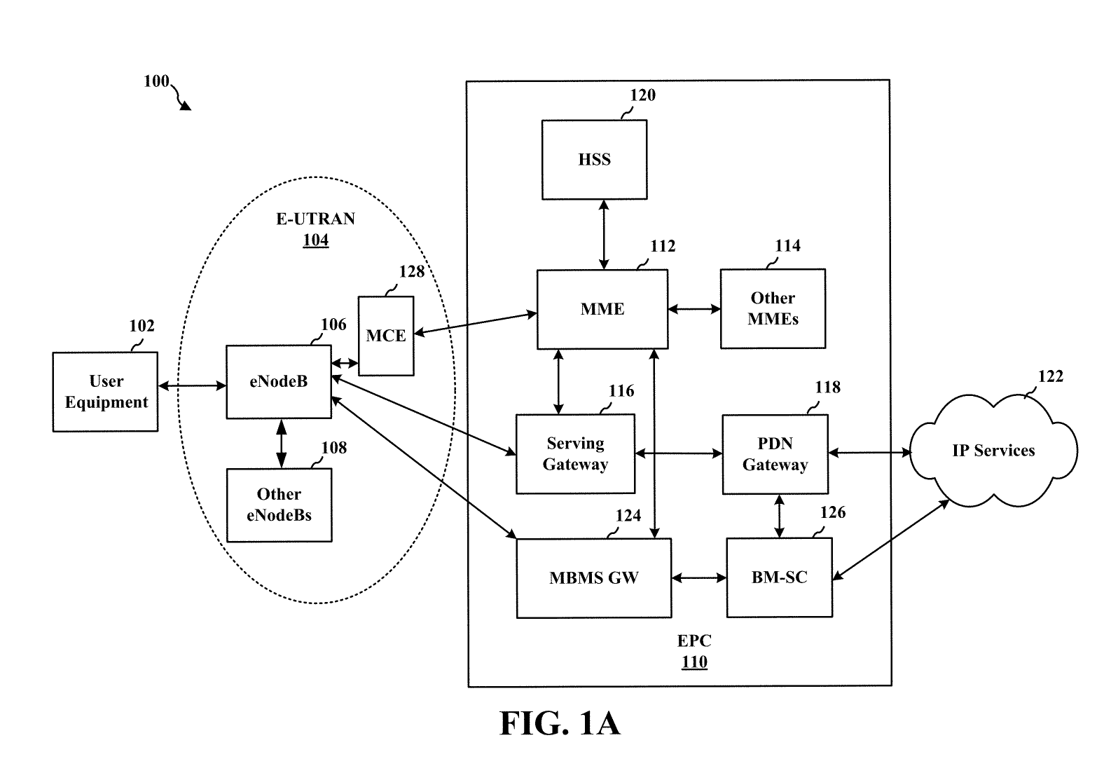

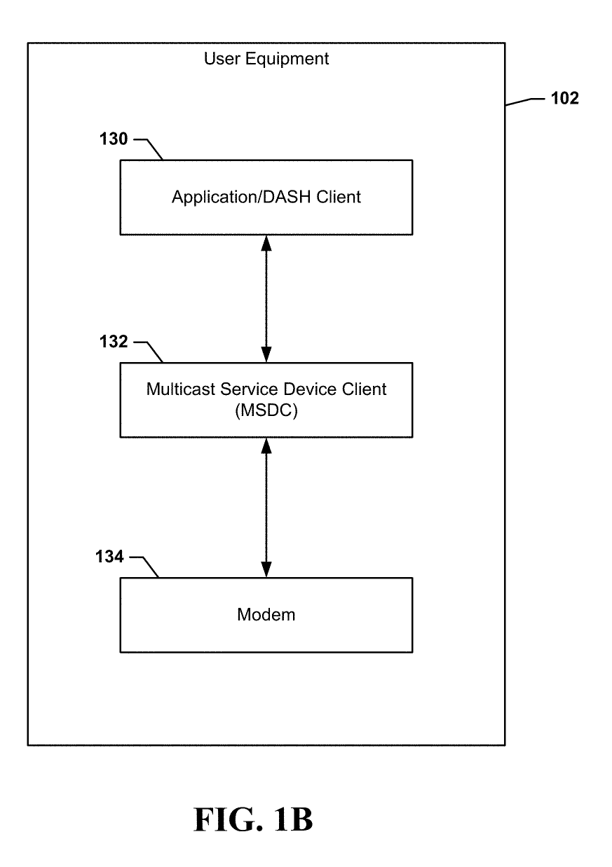

FIG. 1A is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

FIG. 1B illustrates a simplified user equipment 102 architecture suitable for use with various embodiments. The user equipment 102 may include a modem layer 134 that manages all radio aspects of the receiver device 102, such as acquisition, handoff, link maintenance, etc. The modem layer 134 may decode a received eMBMS bearer signal and deliver Internet Protocol (IP) packets to the Multicast Service Device Client (MSDC) 132.

The Multicast Service Device Client 132 may be a service layer of the receiver device 102 that recovers segments from the delivered IP packets and makes segments available to applications/clients, such as Application/DASH client 130. As an example, the Multicast Service Device Client 132 may be a service layer that is part of the operating system of the user equipment 102. The Multicast Service Device Client 132 may also recover an MPD from the delivered IP packets. The Multicast Service Device Client 132 may store received segments in a memory of the user equipment 102.

The Application/DASH client 130 may be a DASH enabled application and/or an application which launches a DASH client to present media (directly and/or via another application such as a media player). In various embodiments, the Application/DASH client 130 may obtain the MPD location (e.g., Uniform Resource Locator (URL)) from the Multicast Service Device Client 132, request and receive the MPD from the Multicast Service Device Client 132, and may request segments from the Multicast Service Device Client 132 per the availability timeline in the modified MPD. The Application/DASH client 130 may receive the requested segments from the Multicast Service Device Client 132 and may render the segment contents (directly and/or via another application such as a media player).

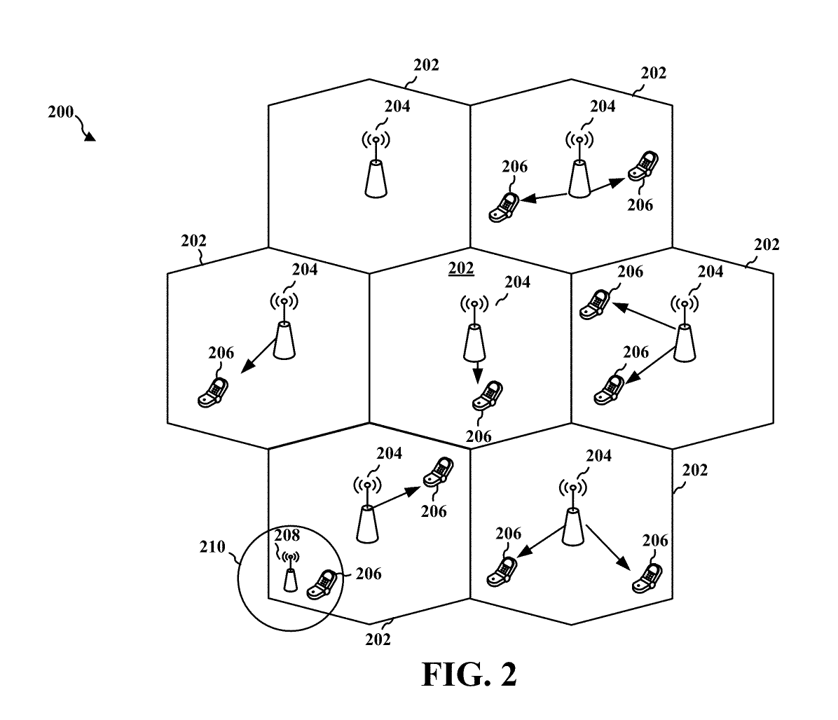

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, frequency-division multiplexing (OFDM) is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

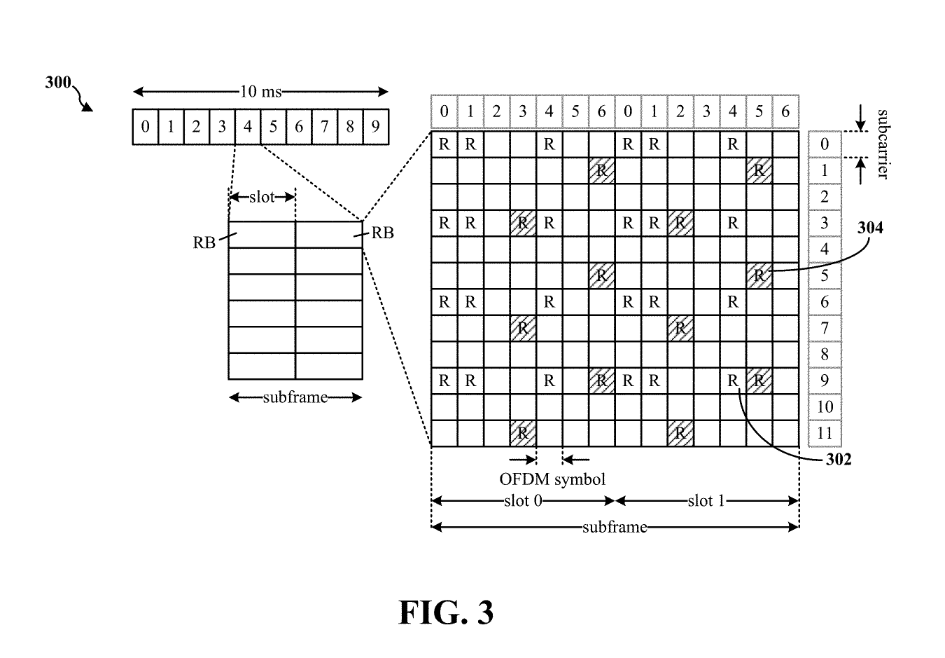

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

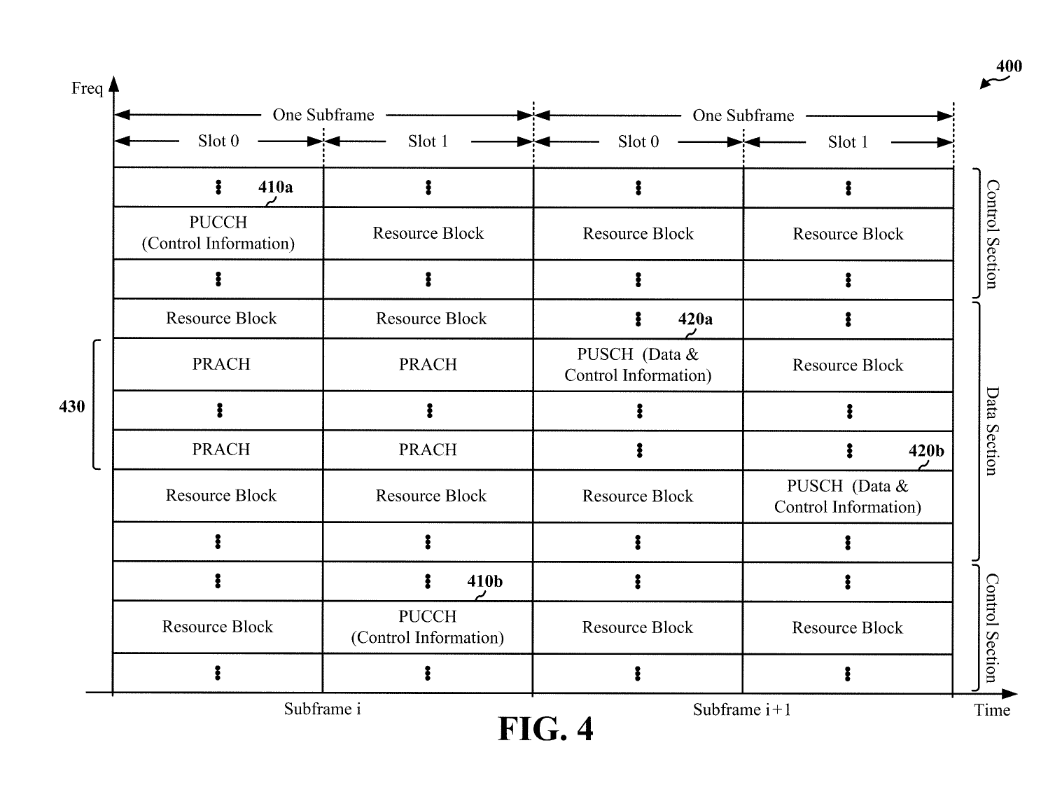

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

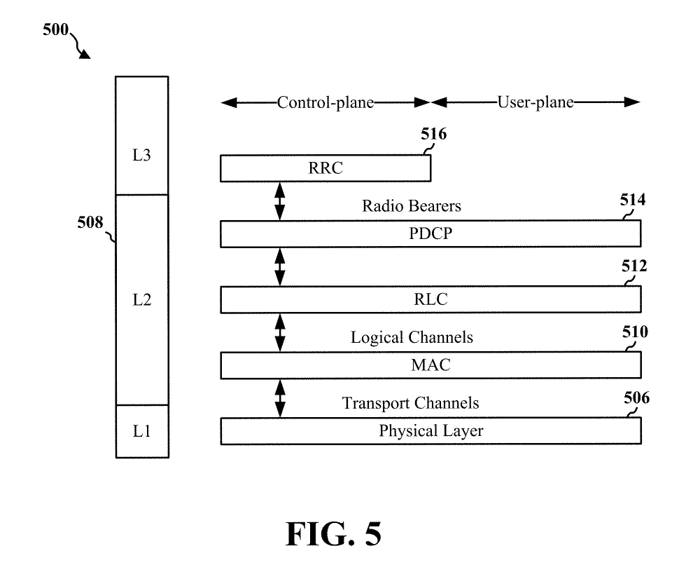

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

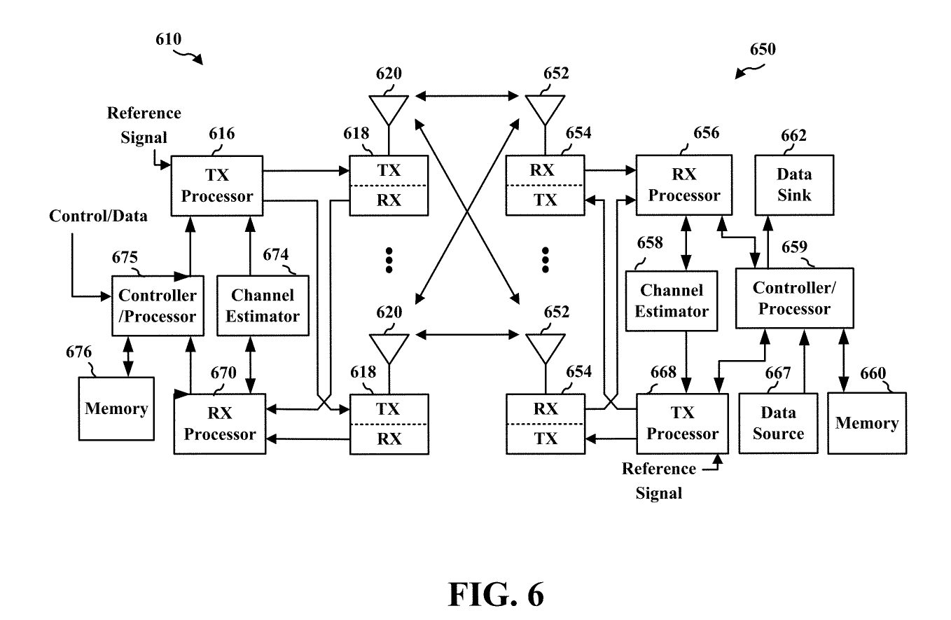

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter TX 618. Each transmitter TX 618 may modulate an RF carrier with a respective spatial stream for transmission.

At the UE 650, each receiver RX 654 receives a signal through its respective antenna 652. Each receiver RX 654 recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

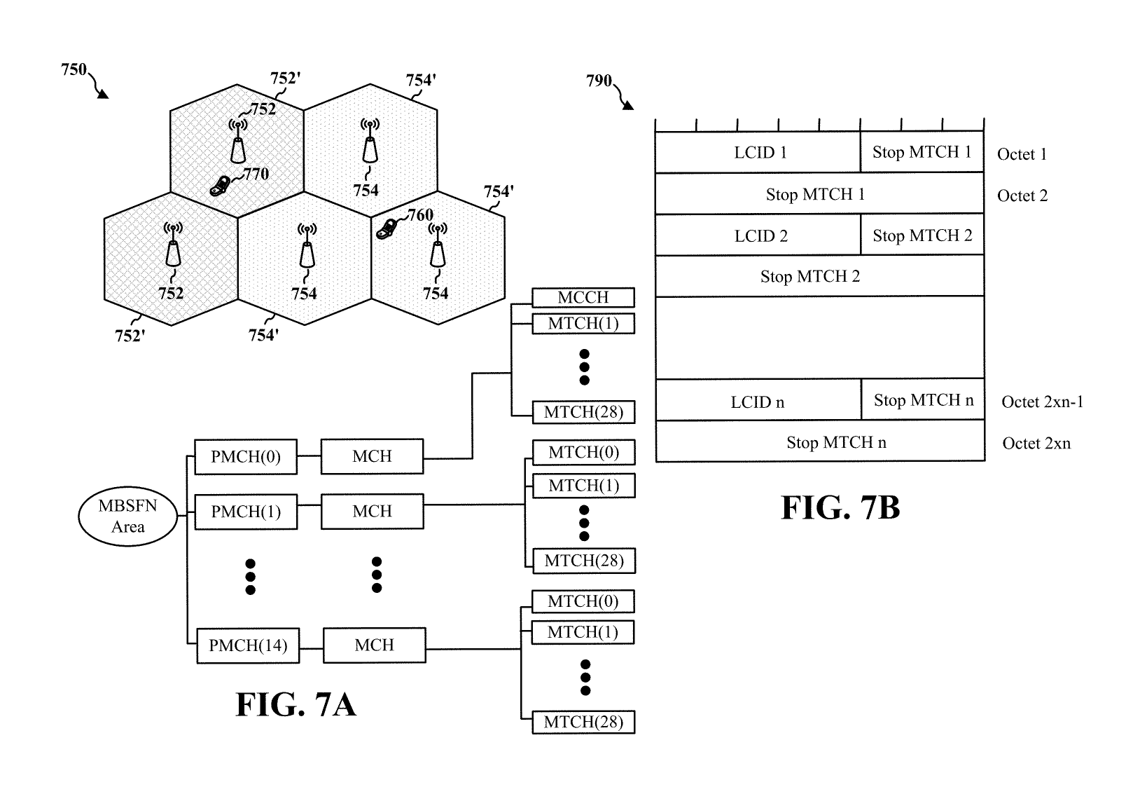

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports one or more physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. Initially, the UE may acquire a system information block (SIB) 13 (SIB13). Subsequently, based on the SIB13, the UE may acquire an MBSFN Area Configuration message on an MCCH. Subsequently, based on the MBSFN Area Configuration message, the UE may acquire an MCH scheduling information (MSI) MAC control element. The SIB13 may include (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may indicate (1) a temporary mobile group identity (TMGI) and an optional session identifier of each MTCH identified by a logical channel identifier within the PMCH, and (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 7B is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area.

In HLS, a UE may achieve media playback by retrieving media segments over HTTP, and by playing the media segments in the correct order. The UE may use a playlist file, that includes URIs of the media segments, to identify locations where the media segments may be accessed and an order in which the media segments are to be played. When live content is being broadcast or multicast (e.g., via eMBMS), the playlist file may be updated frequently as the media segments are generated, as media segments are removed to keep the playlist file size small (e.g., because all UEs are likely playing the same file or the same few files of live content, old files may be removed from the playlist), or the like. When the playlist file is updated, the update may be broadcast or multicast to UEs using eMBMS. However, if the UE loses communication with an eNB that is broadcasting or multicasting the update to the playlist file, the UE may not receive the update to the playlist file. In this case, the UE may not be able to identify a media segment to be retrieved because the playlist file has not been updated to include a URI for the media segment. When this happens, playback of the media content may stall or download of a data file or application update may fail. Techniques described herein assist a UE in preventing stalling of playback of media content or enabling full download of a data file or application update that failed by providing a template for the UE to use to generate URIs for media segments that become available at set times or intervals. The UE may generate the URIs so that the media segments may be identified and retrieved even if the UE fails to receive the URIs via an update to a playlist file (e.g., because the UE has lost communication with an eNB). Further details are described herein.

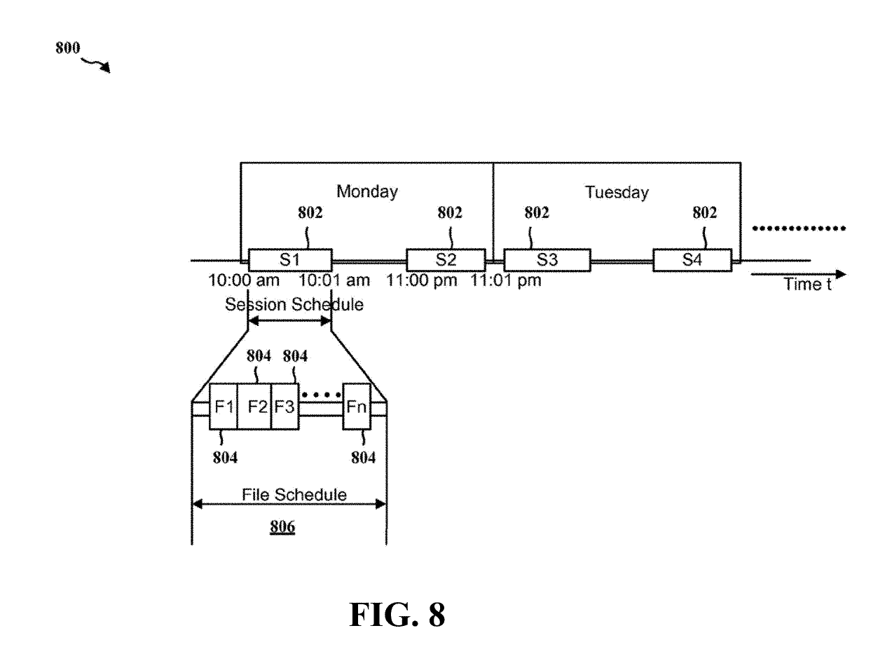

FIG. 8 is an illustration 800 of a portion of a schedule for session and file broadcasts over an eMBMS broadcast. The schedule includes a number of individual session schedules 802 having one-minute durations. During each session schedule 802, one or more files 804 may be broadcast in accordance with a file schedule 806. Information related to the session schedule 802 and the file schedule 806 may be included in a service announcement broadcast by an eMBMS server. Information included in the file schedule 806 may specify specific blocks of time within the sessions, during which specific files 804 will be broadcast.

A UE may have a previously downloaded version of a file 804 that is periodically updated, or may be a subscriber to a service that periodically broadcasts files. For example, a UE may have a particular version of a file, e.g., application, operating system, etc., that is periodically updated by the developer of the file, or the UE may subscribe to a news service that broadcasts files of news stories periodically, e.g., every hour. In a typical eMBMS scenario, an updated version of a file (or new files) may initially be broadcast in the eMBMS service area in accordance with information provided in a service announcement received by the UE prior to broadcast of the file. For example, the service announcement may include a schedule description fragment, which typically includes information corresponding to a session schedule 802 and a file schedule 806. The service announcement may also be received by the UE over a unicast transmission. A file scheduled to be broadcast may be a “file of interest” to a UE. For example, an application on the UE may express interest in receiving files that meet certain criteria on an eMBMS service. A typical criterion is a file name or files in a directory; examples could be all files in the weather folder of a news service. UE may or may not have a version of the file which may or may not be the latest version of the file.

During the time between receipt of the service announcement by the UE and the scheduled eMBMS broadcast of a file of interest, the UE may fall out of service or out of coverage of the eMBMS broadcast and thus not receive the file of interest. “Out of coverage,” relates to cases where the UE moves to an area that is outside of the broadcast area of the eMBMS broadcast. “Out of service” relates to cases where the UE is in a location, e.g., a fringe area of cell or pocket of cell, where the UE cannot reliably receive the broadcast signal, e.g., because the signal strength is too low. That is, the signal may be too weak for the UE to decode the incoming transmission. In either case, the UE does not receive the file of interest and may not receive any partial data at all for the file. Furthermore, the UE may not receive the file delivery table (FDT) instance associated with the file, which lists a set of files, possible signature of the files (in the form of a MD5 hash in the case of FDT), and the corresponding transport options.

Following are several example scenarios where a UE does not receive the file of interest or its associated FDT instance:

1) The UE is tuned to another frequency—Sam is subscribed to a real-time “BBA Live” basketball MBMS video service which allows her to watch live basketball games on her device. The real-time service is broadcast over MBMS using frequency band 1. Sam's mobile device is also configured to receive software updates via an MBMS Firmware Over the Air (OTA) service that is broadcast on frequency band 2. Sam has been watching a live BBA game on her device during the time that a firmware download for her device has been scheduled for delivery over the MBMS Firmware OTA service. Having missed the broadcast delivery window for the file while Sam was watching the game, the device retrieves the software update from a file repair server.

2) The UE is powered-off—Tom is a news junkie who is subscribed to the “CNN” news service which periodically broadcasts news articles throughout the day. Tom regularly commutes between Boston and San Diego for work every week and is diligent about placing his phone in “airplane mode” when he flies. During his flights, Tom's phone is unable to download the news articles that are broadcast while he is in the air. When Tom lands he disables “airplane mode” and his device downloads the missing news articles from the file repair server so that Tom can start catching up on his news feed.

3) The UE is out of MBMS coverage but in good unicast coverage—Beth is a postwoman who delivers mail in some areas without eMBMS coverage (e.g., the MBMS signal is weak). Her Global Positioning System (GPS) relies on broadcast traffic updates for route selection. While in the areas with low coverage, the device downloads missing traffic updates from the file repair server so that Beth's GPS can select the best travel routes.

In cases where a UE does not receive a file of interest, the UE may implement a full file repair. “Full file repair” relates to a full download of the file of interest from a file repair server. File repair in eMBMS is currently triggered by the expiry time of a FDT instance within the file delivery over unidirectional transport (FLUTE) protocol. The existing file repair approach requires the device to access the eMBMS bearer carrying the eMBMS server and download an FDT before being able to initiate file repair. However, in the scenarios described above, the FDT is not available at the UE. Accordingly, current full file repair techniques are not applicable for recovering files for which no FDT is received.

With the addition of a schedule fragment in the eMBMS service announcement, the UE may be aware of sessions and file schedules without necessarily accessing the service and consequently without obtaining the FDT. Described below are techniques applicable to the above three scenarios (and other similar scenarios) that allow a UE to implement a full file repair of a file of interest from a file repair server in cases where the UE is unable to receive the file of interest and the FDT instance for the file, over the broadcast channel during the scheduled delivery of the file. In the disclosed techniques, the UE may obtain the associated delivery procedure description fragment and/or the schedule description fragment for a file of interest. These may be obtained by the UE through an eMBMS service announcement while the UE is in eMBMS coverage, or through a unicast transmission to the UE. For example, the UE may receive the service announcement while in eMBMS service coverage, prior to falling out of coverage or out of service and “missing” the broadcast of the file of interest. Alternatively, the UE may receive the service announcement after the broadcast of the file of interest. “Missing a broadcast”, as used herein, refers to an instance where a UE is unable to receive the transmission of a file of interest through an eMBMS service whereby no FDT is received for the file as exemplified in the discussed scenarios.

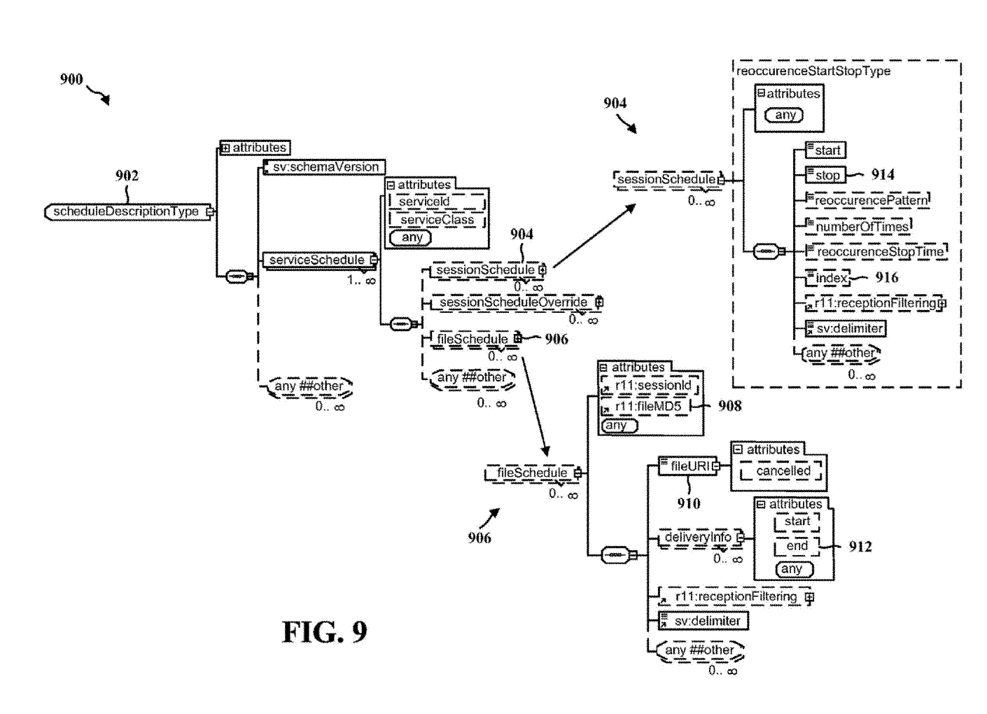

FIG. 9 is a graphical illustration 900 of the XML schema of a schedule description fragment 902. The schedule description fragment 902 may be included in a service announcement received by the UE. Based on information included in the schedule description fragment 902, the UE is able to determine if the UE missed a file of interest. The schedule description fragment 902 includes a session schedule element 904 for the session in which the file of interest is broadcast, and may include a file schedule element 906 for the file of interest. If a file schedule 906 is present, the file schedule may include file version information. For example, the file schedule 906 may have a message digest 5 (MD5) 908 of the file, which identifies the version of the file.

To determine whether a UE missed a file of interest, the UE may monitor the schedule description fragment 902 for file identification information corresponding to a file of interest. For example, the session schedule element 904 may provide the broadcast schedule of the file of interest. The file schedule 906 may include a MD5 908 for the file of interest that identifies the version of the file of interest scheduled for download. Based on this information, the UE compares the version of the file of interest that it currently has, to the version scheduled for download to determine if the UE missed a file of interest and should implement a full file repair. In some cases, however, the schedule description fragment 902 may not include information sufficient to determine if a file of interest was missed. For example, a file schedule 906 may not include a MD5, or the file schedule 906 itself may not be included in the session description 902.

Depending on whether the file schedule 906 is available, and further depending on what information is included in the file schedule, different techniques are disclosed for determining whether a file of interest was missed and for implementing a full file repair. In summary, in these techniques the UE may determine whether a file of interest was missed and if missed, trigger a full file repair based on information included in a schedule description fragment (e.g. file identification information included in a session schedule and file version information included in a file schedule), based on information included in, or obtained through, a schedule description fragment (e.g., a file identification included directly in a session schedule and location information that directs the UE to file version information), based on queries for additional file information, or based on requests for the file of interest from symbol-based repair servers and conventional HTTP servers.

File Repair Based on File Information in Schedule Description:

With continued reference to FIG. 9, a UE may trigger a full file repair based solely on information included in a schedule description metadata fragment 902. The schedule description fragment 902 may include a session schedule element 904, a file schedule element 906 including a MD5 908, and retransmission schedules. In this implementation, the schedule description fragment 902 may be used to determine one or both of the end of a session and the end of a file transmission. Reception reporting may also report failure if a file is not downloaded at the end of the scheduled transmission in the schedule description.

The schedule description fragment 902 describes the transmission of sessions and files. The schedule description fragment 902 may include a session schedule element (sessionSchedule) 904 and a file schedule element (fileSchedule) 906. The file schedule element 906 allows the UE to determine if a file of interest is transmitted. Furthermore, the MD5 908 within the file schedule element 906 allows the UE to determine if a new version of a file of interest is transmitted or scheduled to be transmitted in case the UE had already downloaded the file of interest previously.

A UE may implement full file repair using information in the schedule description fragment 902 as follows: First, the UE determines that a file included in the file schedule 906 is a file of interest. For Example, while within eMBMS coverage, the UE may receive a service announcement that includes broadcast information, e.g., a session schedule 904 and a file schedule 906, for one or more files. Based on the broadcast information, the UE determines if one of the files to be broadcast is a file of interest. The UE may make this determination by checking for a new file or updated MD5 908 for a uniform resource identifier (URI) 910 of interest in the file schedule 906.

During the schedule broadcast of the file of interest, the UE may try to access the corresponding eMBMS bearer to initiate download of the file of interest. If the UE is out of service or out of coverage of the eMBMS or the frequency on which the file is broadcast via eMBMS is inaccessible to the UE, then the UE is unable to download the file of interest. In this case, the UE may trigger full file repair at file schedule end or session schedule end. For example, the UE may start full file repair when the end of the file transmission time is reached. The end of the file transmission time may be included in the end attribute 912 of the file schedule element 906. Alternatively, the UE may start full file repair at the end of the session containing the file of interest. Accordingly, the UE may trigger file recovery at file schedule end or session schedule end, even when the FDT instance is not received.

Thus, in this procedure, the UE determines that a file of interest is transmitted within a service based on the file schedule information. To this end, the UE requires file information to include a file schedule and optionally a session schedule as well. The UE processes the file information to determine if any files identified in the file information correspond to a file of interest. For example, if the file information identifies a file in the weather director of a news service and an application has already requested the reception of such files, then the UE would identify such files as files of interest.

The UE determines a failure to download the file of interest. To this end, the UE, having knowledge of the broadcast schedule of the file of interest, may attempt to establish an eMBMS bearer by which to receive the file. If establishment of the bearer fails or if multiple such attempts fail for part or for the total duration of the broadcast of the file according to the schedule description, then the UE would determine a failure to download the file of interest. In another possible implementation, the UE may determine a failure to download a file of interest, subsequent to the scheduled broadcast, by comparing the version of the file currently on the UE with the version of the file of interest broadcast during the session as announced in the schedule description. If the versions do not match, then the UE may conclude there was a failure to download the file of interest.

If there was a failure to download a file of interest, the UE may trigger a repair procedure of the file of interest at a time corresponding to an end of a file delivery event. To this end, the UE establishes a connection with the file repair server where the file of interest is located and requests the file. The UE may receive the file from the file repair server through a unicast transmission.

In one implementation of the foregoing, the file delivery event includes a file broadcast, the information element includes a file schedule element 906 included in a broadcast schedule description 902, and the time of the repair trigger corresponds to the end of the file broadcast, as provided by the end attribute 912 of the file schedule element 906. In another implementation, a UE obtains a broadcast schedule description 902 including a file schedule 906 for a file of interest, and triggers a full file repair procedure of the file of interest at a time based on an end attribute 912 included in the file schedule.

File Repair Based on FDT (File Schedule Unavailable):

As previously mentioned, a file schedule may not be included in a schedule description fragment 902. For example, in some cases the number of files to be broadcast during a session may be too numerous to include in a file schedule. In these cases, the UE may determine from application preferences that a file of interest may be broadcast during an upcoming session. When the UE is able to receive eMBMS, the UE activates the bearer carrying the service at the beginning of the session, receives all file transmissions of files of interest during the session and deactivates the bearer at the end of the session. When the UE is unable to activate the bearer at the beginning or during the session (in the cases where full file repair is needed), the UE is unable to obtain the list of files that are broadcast in the session, and is therefore unable to determine if a file of interest is actually included in the session. In accordance with a technique, a UE may obtain file information based on FDT information included in a session schedule element 904, and trigger a full file repair of a file broadcast during the session if the UE determines the one or more files is a file of interest.

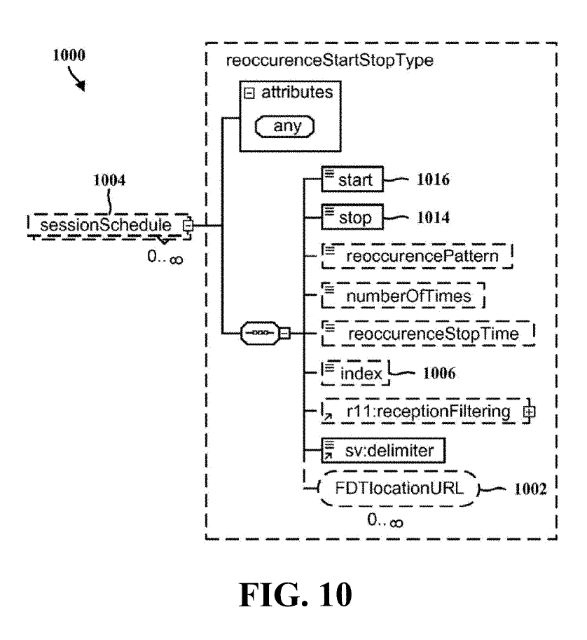

In one configuration, and with reference to FIG. 10, file information is provided by an FDT location URI 1002 included in a session schedule element 1004. FIG. 10 is a graphical illustration 1000 of the XML schema of a session schedule element 1004. The FDT location URI 1002 may be available at broadcast start (as indicated by the start attribute 1016), at broadcast end (as indicated by the stop attribute 1014), or at broadcast end plus an offset time. The latter availability option is preferred since this is when the file repair files are available on the file repair server in the current standard operating protocols.

The FDT location URI may include information that describes all of the files transmitted during the broadcast session. The FDT location URI 1002 can be a template parameterized by sessionIndex 1006. For example, the FDT location URI 1002 may include file information that is categorized by session number. For example, a URI may be

http:\\provider.com\filedeliveryservice\FDT1, for session 1,
http: \\provider.com\filedeliveryservice\FDT2, for session 2,
http: \\provider.com\filedeliveryservice\FDT2, for session 3, etc.

A UE may implement full file repair based on a FDT when a file schedule is not available as follows: First, the UE determines applications are interested in files on a broadcast service with session schedule announced in a service announcement. For example, based on information included in a service announcement, the UE may determine that a file of interest may be broadcast on a corresponding eMBMS bearer.

The UE may try to access the eMBMS bearer to initiate file download. If the UE is out of service due to a weak eMBMS signal, or the UE is out of coverage of the eMBMS broadcast, or the UE is unable to switch to the frequency on which the service is broadcast, or the UE cannot receive the eMBMS broadcast for any other reason (radio resource issues, too many bearers active, etc.) then the UE is unable to download the file of interest. In this case, the UE queries for the FDT information, e.g., the FDTlocationURl attribute 1002, of the session schedule 1004 to determine whether a file of interest was broadcast during the session. The UE may have to wait until the end of the broadcast session plus an offset time, where the session end is provided by the stop attribute 1014 of the session schedule 1004. Based on the FDT information the UE determines the files in the session and their MD5s, if specified. For example, the UE may review the files listed as URIs and each file's corresponding MD5 version to determine if any of the files are new or if any of the file correspond to newer versions of files present on the UE. If a file of interest is found (a new file or a newer version of a file), the UE triggers a full file repair for the file of interest. The full file repair may be triggered at the end of the broadcast session. The end of the broadcast session may be determined based on information included in the session schedule.

Thus, in this procedure, the UE determines that a file of interest is transmitted within a service. To this end, the UE may obtain file broadcast information, e.g., a service announcement, including a schedule description fragment having a session schedule with location information of where a FDT is located, and process this information by accessing the FDT and determining if any files indentified in the file broadcast information correspond to a file of interest that is listed in the FDT. Based on the session schedule, the UE may determine that a file of interest may be broadcast during the session. Based on the FDT location information obtained through the session schedule, the UE may determine if a file of interest was actually broadcast during the session. In one implementation of the foregoing, the UE determines that a file of interest is transmitted within a service based at least in part on information included in a FDT obtained through an FDT locator 1002 included in a schedule description of a session. For example, the FDT locator 1002 may be in a session schedule 1004 element of a schedule description fragment. In another implementation, a UE obtains a broadcast schedule description including a session schedule 1004 for a file of interest and retrieves a FDT for the file of interest based on a FDT URI 1002 included in the session schedule.

The UE determines a failure to download the file of interest. To this end, as described above, the UE determines that it cannot access the eMBMS bearer to initiate a download and then queries for FDT information.

If there was a failure to download a file of interest, the UE may trigger a repair procedure of the file of interest at a time corresponding to an end of a file delivery event. To this end, the UE establishes a connection with the file repair server where the file of interest is located and requests the file. The UE may receive the file from the file repair server through a unicast transmission. The UE triggers a repair procedure of the file of interest at a time based on a stop attribute 1014 included in the session schedule 1004.

File Repair Based on Schedule Description (File Schedule Unavailable):

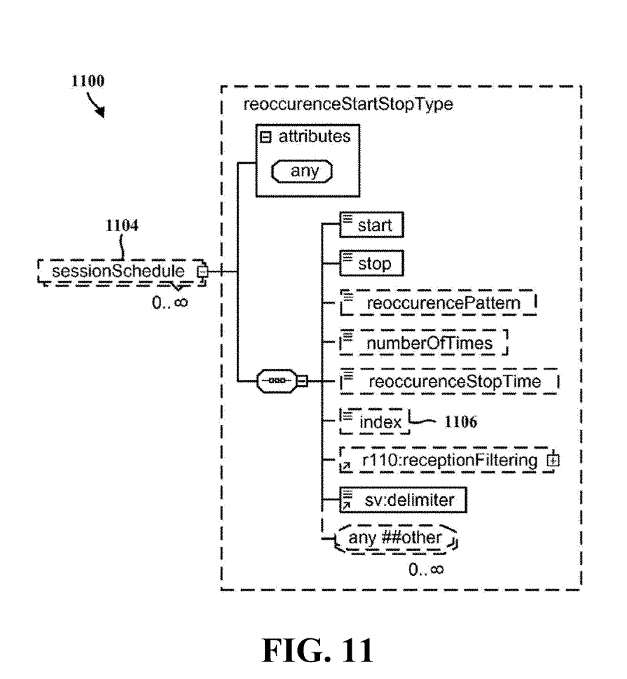

In another technique where a file schedule element 906 is not included in a schedule description fragment 902, a UE may obtain file information from a session schedule element 904, and trigger full file repair of a file of interest. With reference to FIG. 11, in this procedure, there is no change to the session schedule element 1104. FIG. 11 is a graphical illustration 1100 of the XML schema of a session schedule element 1104. The main difference is that the UE, on failing to access a session and on being unable to GET any FDT describing the files broadcast in the session, retrieves a more up to date schedule description that also includes the file schedule of files available through the file repair server.

In this procedure, the UE may query the eMBMS server for broadcast file information by querying for the latest version of the schedule description fragment 902 for the session during which the file of interest is being broadcast. The broadcast file information may be included in a file schedule 906 that is included in the latest version of the schedule description fragment 902. The schedule description fragment 902 may be received by the UE through a unicast transmission. In one aspect the UE may query for a schedule description of a session identified by a service identifier included in a universal service description (USD) or by a session index 1106 included in a session schedule 1104. In another aspect the UE may use a unicast channel to get the latest version of the schedule description fragment 902 which provides a file schedule 906 if file repair is enabled as per the Associated Delivery Procedure fragment. Note that the schedule description fragment is identified by a URI in the service announcement, and in one embodiment, this file URI could be used to retrieve an updated version of the schedule description fragment from the file repair server.

A UE may implement full file repair based on schedule description when a file schedule is not initially available as follows: First, the UE determines capture is active on a broadcast service with a session schedule announced in a service announcement. For example, based on information included in the service announcement, the UE may determine that a file of interest may be broadcast on a corresponding eMBMS bearer.

The UE may try to access the eMBMS bearer to initiate file download. If the UE is out of service due to weak eMBMS signal, or the UE is out of coverage of the eMBMS broadcast, or the UE is unable to switch to the frequency on which the service is broadcast, or the UE cannot receive the eMBMS broadcast for any other reason (radio resource issues, too many bearers active, etc.) then the UE is unable to download the file of interest and a potential failure to download the files is established. In this case, the UE queries for an updated schedule description 902 of the session including a file schedule 906 if file repair is available.

Based on the schedule description 902, the UE determines the files in the session and their MD5s, if specified. For example, the UE may review the files listed in a file schedule 906 and the corresponding versions as provided by the MD5s to determine if any of the files correspond to newer versions of files present on the UE. If a file of interest is found, the UE may trigger a full file repair for the file of interest. The repair may be triggered at the end of the session/file schedule, as provided by the latest updated schedule description fragment 902.

Thus, in this procedure, the UE determines that a file of interest is transmitted or will be transmitted by a service. To this end, the UE may obtain file broadcast information, e.g., through reception of a service announcement including a session schedule having file information, and by querying for an updated session schedule 904 having a file schedule with file version information. The UE processes file information to determine if any files identified in the broadcast information correspond to a file of interest. Based on the session schedule, the UE may determine that a file of interest may be broadcast during the session. Based on the file schedule 906, the UE may determine if a file of interest was broadcast during the session. Accordingly, the UE determines that a file of interest is transmitted by a service based on information included in an updated schedule description, which may be obtained via a unicast transmission.

The UE may determine a failure to download the file of interest. To this end, as described above, the UE determines that it cannot access the eMBMS bearer to initiate a download and then queries for an updated schedule description.

If there was a failure to download a file of interest, the UE may trigger a repair procedure of the file of interest at a time corresponding to an end of a file delivery event. To this end, the UE establishes a connection with the file repair server where the file of interest is located and requests the file. The UE receives the file from the file repair server through a unicast transmission.

File Repair Based on a Session Index (File Schedule Unavailable):

In another technique applicable to instances where a schedule description fragment 902 may not provide a file schedule element 906, a UE may trigger full file repair of a file of interest based on session index information 916 included in a session schedule element 904 of a schedule description fragment 902.

In this approach a session index 916 that uniquely identifies a session may be used to identify retransmissions in the schedule description 902. For example, the session index 916 can be used to identify repeated sessions in the schedule description. The session index 916 is associated with content. If the current session carries the same files as a previous session, then the same index is used to broadcast the session.

UE behavior for full file repair based on session index 916 when file schedule is not available is as follows: First, the UE determines capture is active on service with session schedule announced in service announcement. For example, the UE may determine that a file of interest is being broadcast on a corresponding eMBMS bearer.

If the UE determines that the current session index 916 matches a previous session index for which all files of interest were received successfully, the UE does not initiate any download on the repeated session. If the UE determines that the current session index 916 does not match a previous session index for which all the files of interest were received successfully, the UE initiates full file repair on the repeated session.

Thus, in this procedure, the UE determines that a file of interest is transmitted within a service. The UE determines that a file of interest is transmitted within a service based on a comparison between an index associated with files broadcast during a previous session and an index associated with files broadcast during a current session. If the indexes do not match, the UE may conclude there is a file of interest. The UE then determines a failure to download the file of interest. This may be done as described for previous techniques. The UE may then trigger a repair procedure of the file of interest at a time corresponding to an end of a file delivery event. This too may be done as described for previous techniques.

File Repair Based on Implicit FDT (No MD5 in File Schedule):

In a technique for use when a file schedule element 906 is available but does not include file version information, e.g. no MD5, a UE may trigger full file repair upon determining a file of interest based on an implicit FDT location. Because the schedule description fragment 902 does not provide a MD5 908 for a file URI in the file schedule element 906, the UE is unable to determine the version of the file corresponding to the URI and is thus unable to determine if the corresponding file is a file of interest.

In this scenario, a UE may implement full file repair based on an implicit FDT as follows: First, the UE determines that a file included in the file schedule 906 is a file of interest. For example, the UE may determine the URI 910 identified in the file schedule 906 is a file of interest based on having previously downloaded the file.

The UE may try to access the corresponding eMBMS bearer to initiate download of the file of interest. If the UE is out of service or out of coverage of the eMBMS or the frequency on which the file is broadcast via eMBMS is inaccessible to the UE, then the UE is unable to download the file of interest. The URI 910 included in the file schedule 906 includes FDT information that may include the MD5 of the file of interest. The FDT location may be implicit based on the file URI, e.g., same directory of the URI but file name is “FDT.” The UE downloads the FDT that contains the MD5 of the file of interest. Then, the UE may trigger file repair at file schedule end or session schedule end. For example, the UE may start the associated delivery procedure when the end of the file transmission time is reached. The end of the file transmission time may be included in the end attribute 912 of the file schedule element 906. Alternatively, the UE may start the associated delivery procedure at the end of a session. The end of the session time may be determined based on the stop attribute 914 of the session schedule element 904.

Thus, in this procedure, the UE determines that a file of interest is transmitted within a service. The UE determines that a file of interest is transmitted within a service based at least in part on information included in a FDT obtained through an FDT locator implicitly determined from the locator of the file of interest. For example, the UE may determine the URI 910 identified in the file schedule 906 is a file of interest based on having previously downloaded the file of interest. This may be done as described for previous techniques. The UE then triggers a repair procedure of the file of interest at a time corresponding to an end of a file delivery event. This too may be done as described for previous techniques.

File Repair Based on Query (No MD5 in File Schedule):

In another technique for use when a file schedule element 906 is available but does not include file version information, e.g. no MD5, a UE may trigger file repair upon determining a file of interest based on a query. In this case, because the UE does not have MD5 information, it is unable to determine the version of files scheduled for download, and is thus unable to determine if any of the files scheduled for broadcast are files of interest. The UE, however, is provided with a query procedure that allows the UE to inquire about the latest MD5 of a file on the file repair server.

A UE may implement full file repair based on a query as follows: First, the UE determines that a file included in the file schedule 906 may be a file of interest. For example, the UE may compare its files with the files listed in the file schedule to determine if any files in the file schedule were previously downloaded by the UE. Any previously downloaded file would be considered a possible file of interest.

The UE may try to access the corresponding eMBMS bearer to initiate download of the file of interest. If the UE is out of coverage or the frequency on which the file is broadcast vie eMBMS is inaccessible to the UE, then the UE is unable to download the file of interest. In this case, the UE requests the latest MD5 information on a possible file of interest included in the file schedule 906 from a file repair server. If the file version information provided by the latest MD5 information does not match the version of the file currently on the UE, the UE concludes the file is a file of interest. Then, the UE may trigger file repair at file schedule end or session schedule end. For example, the UE may start the associated delivery procedure when the end of the file transmission time is reached. The end of the file transmission time may be included in the end attribute 912 of the file schedule element 906. Alternatively, the UE may start the associated delivery procedure at the end of a session. The end of the session time may be determined based on the stop attribute 914 of the session schedule element 904.

Thus, in this procedure, the UE determines that a file of interest is transmitted within a service. The UE determines that a file of interest is transmitted within a service based at least in part on information received by querying for a latest MD5 file. The UE then determines a failure to download the file of interest. This may be done as described for previous techniques. The UE then triggers a repair procedure of the file of interest at a time corresponding to an end of a file delivery event. This too may be done as described for previous techniques.

File Repair Based on a Conditional Get (No MD5 in a File Schedule):

In another technique for use when file version information, e.g., MD5, is not available, a UE may trigger file repair upon determining a file of interest based on a conditional GET procedure. In this case, because the UE does not have MD5 information, the UE is unable to determine the version of files scheduled for download, and is thus unable to determine if any of the files schedule for broadcast are files of interest. Web servers allow conditional gets based on tags of files (“etags”). The conditional GET is directed to the latest version of the file and the etag of the file is the file's MD5 signature. Conditional GET (with conventional HTTP server) with if-none-match: “MD5_Of_Latest_Version_onUE” would return the file if a new version is available based on the etag remaining the same, or return “Not Modified” in case of no change to the file.

A UE may implement full file repair based on a conditional GET as follows: First, the UE determines that a file included in the file schedule 906 is a file of interest and that the file was previously downloaded by the UE. For example, the UE may compare its files with the files listed in the file schedule 906 to determine if any files in the file schedule were previously downloaded by the UE. Any previously downloaded file would be considered a possible file of interest.

The UE may try to access the corresponding bearer to initiate download of the file of interest. If the UE is out of coverage of the frequency on which the file is broadcast via eMBMS is inaccessible to the UE, then the UE is unable to download the file of interest. Then, the UE may trigger file repair at file schedule end or session schedule end. For example, the UE may start the associated delivery procedure when the end of the file transmission time is reached. The end of file transmission time may be included in the end attribute 912 of the file schedule element 906. Alternatively, the UE may start the associated delivery procedure at the end of a session. The end of the session time may be determined based on the stop attribute 914 of the session schedule element 904.

At the time of downloading the file as part of the full file repair, the UE does a conditional GET and requests the file only if the etag of the file on the server is different than the MD5 of the current version of the file on the UE. To do this, the etag of the file on the conventional HTTP file repair server needs to be set to the MD5 of the file version currently being served by the http server.

Thus in this procedure, the UE may determine that a file of interest is transmitted within a service. The UE may determine that a file of interest is transmitted within a service based on a comparison of an identifier, e.g., MD5 signature, of the latest version of the file with a previously downloaded version of the file. The UE then determines a failure to download the file of interest. This may be done as described for previous techniques. The UE may then trigger a repair procedure of the file of interest at a time corresponding to an end of a file delivery event. This too may be done as described for previous techniques.

File Repair Based on Conventional HTTP Server Support with Schedule Description Fragment:

In the current LTE specification 3GPP TS 26.346, version 12.1, section 3.5.1, a FDT may include: “Alternate-Content-Location-1” and “Alternate-Content-Location-2” elements that provide the references to a file repair server resource via the “xs:anyURT” value. At least one “Alternate-Content-Location-1” element is present in the FDT if byte-range based file repair is to be supported by the network. The “Base-URL-1” and “Base-URL-2” elements, when present, provide base URLs against which to resolve a relative reference included in any “Alternate-Content-Location-1” or “Alternate-Content-Location-2” element, respectively. The “Availability-Time” attribute, when present, provides a method to inform the UE of an absolute time according to the Coordinated Universal Time (UTC) time standard until which the UE can expect that, if reachable and functioning, the file repair server will return the requested repair data.

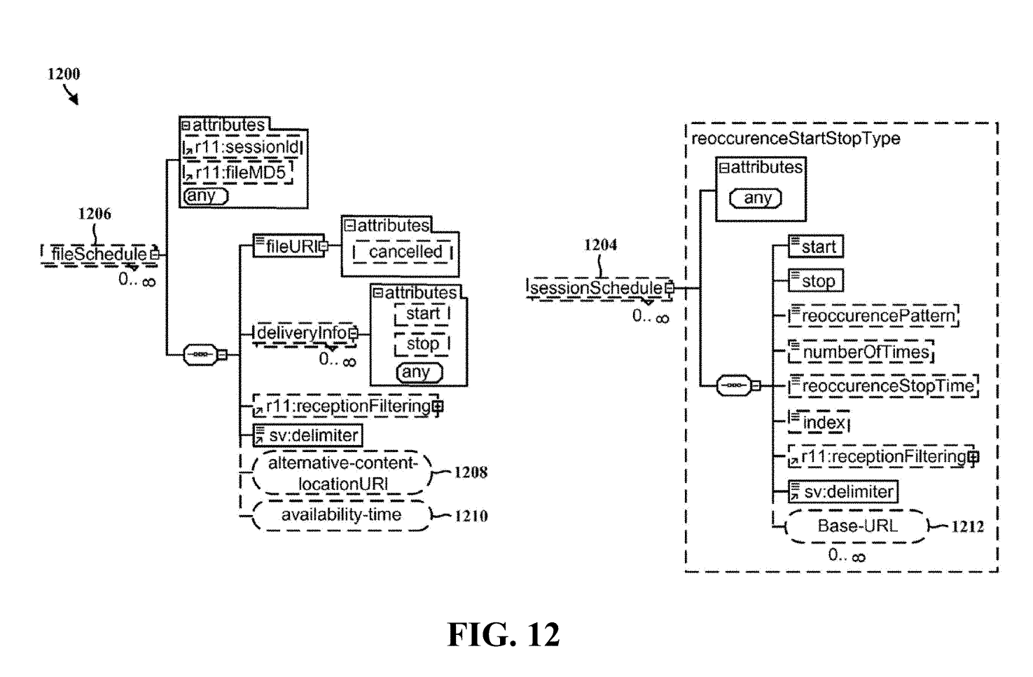

Two options for full file repair may be provided with the conventional HTTP server support with schedule description fragment approach. In a first option, FDT retrieval may be used as described above with respect to file repair based on FDT, to obtain conventional HTTP server locations as outlined in FDT. In a second option, similar support is added in the session schedule element 1204 to support conventional HTTP servers as shown in FIG. 12. FIG. 12 is a graphical illustration 1200 of the XML schema of a session schedule element 1204. This enhancement works best with the above-described full file repair based on query and full file repair based on conditional GET.

In the various file repair techniques described above, file repair is triggered at a time corresponding to an end of a file delivery event. For example, when a file schedule element 906 is available, a UE may trigger file repair at a time corresponding to the end attribute 912 of the file schedule element 906. More specifically, the file repair time based on the file schedule element 906 may be defined as a time specified by the end attribute 912 plus an offset time and a random time period. Alternatively, when a session schedule element 904 is available, a UE may trigger file repair at a time corresponding to the stop attribute 914 of the session schedule element 904. More specifically, the file repair time based on the session schedule element 906 may be defined as a time period specified by the stop attribute 914 plus an offset time and a random time period. However, file repair at the time corresponding to the end of the file delivery event may not be successful. For example, the UE may be in a location where access to the Internet is not possible during the scheduled time, the UE may be turned off, or the server may have issues (e.g., congestion). Therefore, it would be helpful to define additional time windows within which subsequent file repair attempts may be made.

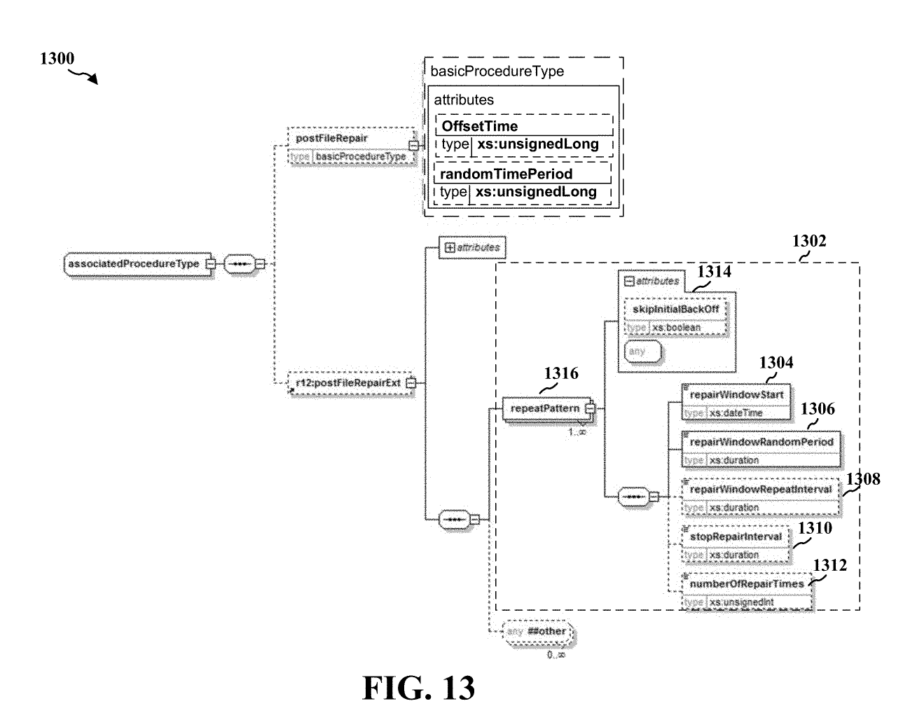

FIG. 13 is a graphical illustration 1300 of the XML schema of an Associated Delivery Procedure Description (ADPD) fragment extension 1302 that defines one or more additional windows for file repair according to some embodiments. The ADPD fragment extension 1302 may be included in a service announcement received by the UE. Based on information included in the ADPD fragment extension 1302, the UE is able to determine additional time window(s) within which additional temps at file repair may be performed. The ADPD fragment extension 1302 may include, for example, a repairWindowStart element 1304, a repairWindowRandomPeriod element 1306, a repairWindowRepeatInterval element 1308, a stopRepairInterval element 1310, a numberOfRepairTimes element 1312, and a skipInitialBackOff attribute 1314.

The repairWindowStart element 1304 may provide, for example, an anchor start time for recurring repair windows when additional file repair may be attempted. The repairWindowRandomPeriod element 1306 may provide, for example, a period of time from the start of a repair window of time during which additional file repair requests may be attempted, enabling the UE to make an attempt to acquire file repair at a randomized backoff time. The repairWindowRepeatInterval element 1308 may provide, for example, a periodicity from the repairWindowStart element 1304 anchor time when additional repair windows start. The stopRepairInterval element 1310 may provide, for example, a period of time from the first repair window after the transmission has ended until when file repair requests can be made. The numberOfRepairTimes element 1312 may provide, for example, a number of file repair requests that can be made from the first repair window after the file transmission has ended. The skipInitialBackoff attribute 1314 may indicate, for example, that no file repair attempt is scheduled per the postFileRepair parameters when set to true and that an additional file repair attempt is scheduled per the postFileRepair parameter when set to false.

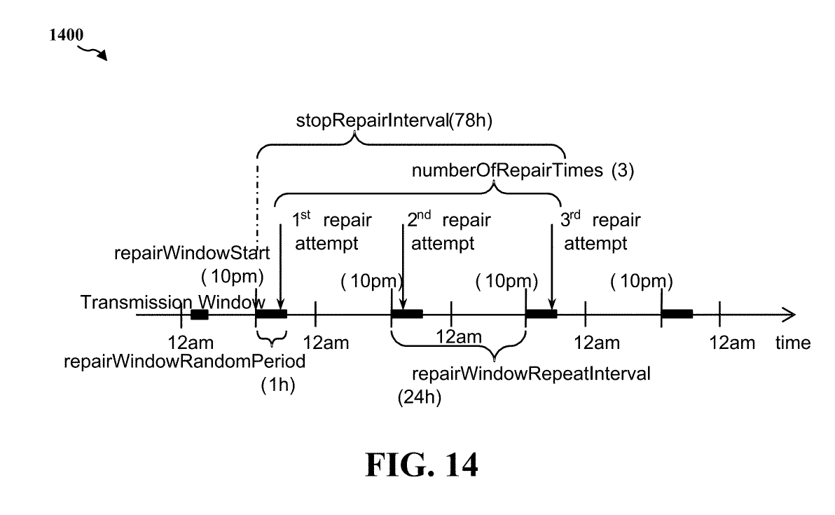

FIG. 14 illustrates an example of a timeline 1400 for file repair attempts based on the ADPD fragment extension 1302 according to such embodiments. In the illustrated example, an initial transmission window occurs shortly after 12AM. That is, files are scheduled for delivery via eMBMS broadcast after 12AM. In this example, the repairWindowStart element 1304 provides an anchor start time of 10PM. Further in this example, the repairWindowRandomPeriod element 1306 provides a period of 1 hour and the repairWindowRepeatInterval element 1308 provides a periodicity of 24 hours. Additionally, in this example, the stopRepairInterval element 1310 provides a period of 78 hours and the numberOfRepairTimes element 1312 provides 3 as the number of file repair requests that can be made.

As illustrated in the example of FIG. 14, each of three (3) subsequent file repair request attempts can be made approximately 24 hours apart during a 78-hour period. Each file repair request may be made at a random time within a 1-hour period starting at 10 PM. In the illustrated example, the first file repair request may occur at approximately 10:45 PM, the second file repair request may occur at approximately 10:15 PM, and the third file repair request may occur at approximately 10:55 PM. In this way, if an initial file repair attempt made at a time corresponding to the end of the file delivery event is not successful, subsequent file repair requests may be made. Performing additional file repair attempts at a random back off time from the start of a repair file availability window reduces the number of UE that will access the repair server simultaneously, thereby minimizing traffic flow on the repair server and reducing the chance that a file repair attempt will fail due to network traffic overload.

In one implementation, a single ADPD fragment extension 1302 may be included in a service announcement received by a UE as indicated by a single repeatPattern element 1316. In this implementation, a timeline for subsequent file repair attempts may be defined using a repeatIteration such that (repairWindowStart+repeatIteration*repairWindowRepeatInterval)>fileSchedule.deliveryInfo@end or FDT@Expires. More specifically, file repair attempts may occur at a time=repairWindowStart+(repeatIteration+i)*repairWindowRepeatInterval+rand[0, repairWindowRandomPeriod] such that 0<=i<=numberOfRepairTimes−1 or 0<=i while repairWindowStart+(repeatIteration+i)*repairWindowRepeatInterval<stopRepairInterval.

In an alternate implementation, multiple ADPD fragment extensions 1302 may be included in a service announcement received by a UE as indicated by multiple repeatPattern elements 1316. In this alternate implementation, a timeline for subsequent file repair attempts may be defined using a repeatIteration[k] such that (repairWindowStart[k]+repeatIteration[k]*repairWindowRepeatInterval[k])>fileSchedule.deliveryInfo@end or FDT@Expires where k represents each ADPD fragment extension 1302. More specifically, file repair attempts may occur at a time=repairWindowStart[k]+(repeatIteration[k]+i)*repairWindowRepeatInterval[k]+rand[0, repairWindowRandomPeriod[k]] such that 0<=i<=numberOfRepairTimes[k]−1 or 0<=i while repairWindowStart[k]+(repeatIteration[k]+i)*repairWindowRepeatInterval [k]<stopRepairInterval[k].

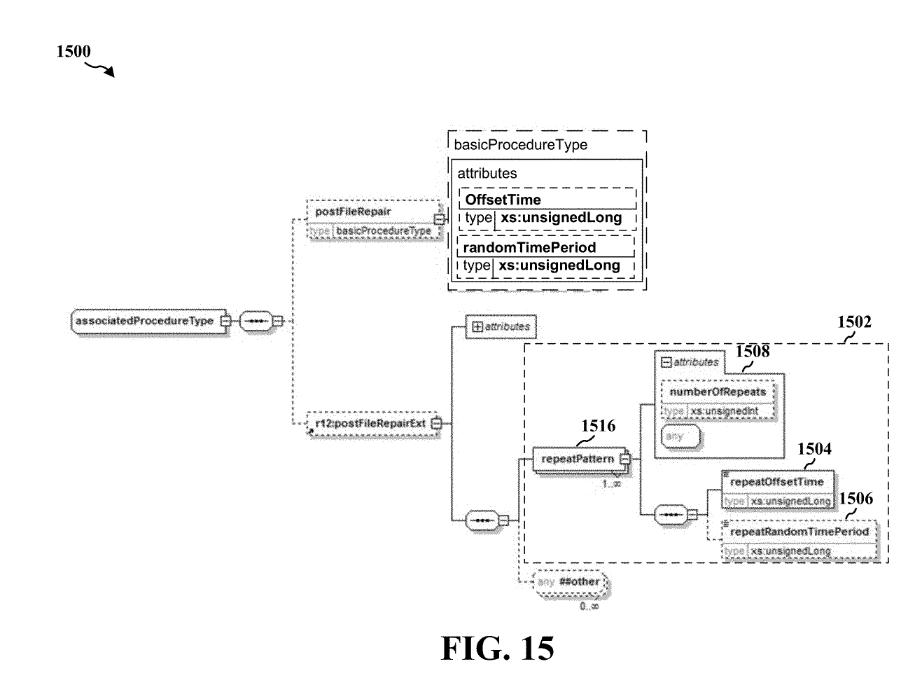

FIG. 15 is a graphical illustration 1500 of the XML schema of an alternate ADPD fragment extension 1502 that defines one or more additional windows for file repair according to some embodiments. The ADPD fragment extension 1502 may be included in a service announcement received by the UE. Based on information included in the ADPD fragment extension 1502, the UE may be able to determine additional window(s) within which requests for file repair information may be attempted. The ADPD fragment extension 1502 may include, for example, a repeatOffsetTime element 1504, a repeatRandomTimePeriod element 1506, and a numberOfRepeats element 1508.

The repeatOffsetTime element 1504 may provide, for example, an additional offset time from an offset time value included in an ADPD fragment at which additional file repair attempts may be scheduled. The repeatRandomTimePeriod element 1506 may provide, for example, an alternative random period to be used when scheduling additional file repair iterations. The numberOfRepeats element 1508 may indicate, for example, a number of additional iterations available for performing file repair attempts.

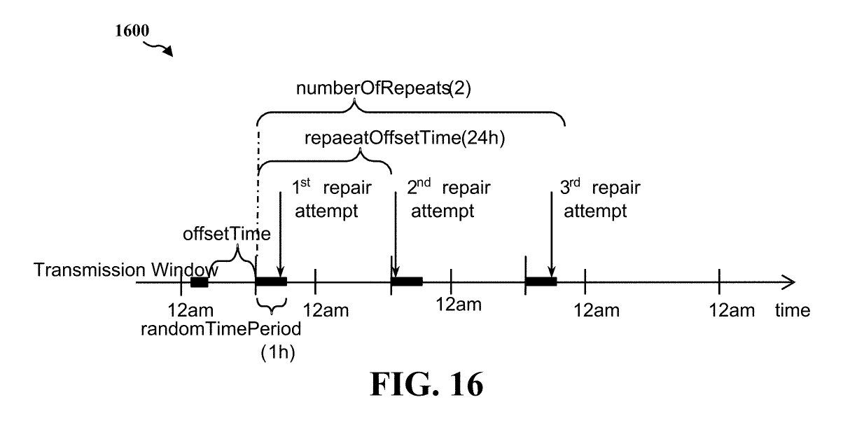

FIG. 16 illustrates an example of a timeline 1600 for file repair attempts based on the ADPD fragment extension 1502 according to such embodiments. In the illustrated example, an initial transmission window occurs shortly after 12 AM. That is, in the illustrated example files are scheduled for delivery via eMBMS broadcast after 12 AM. In this example, an initial offset time is defined and the repeatOffsetTime element 1504 provides an additional offset time of 24 hours. Further in this example, the repeatRandomTimePeriod element 1506 provides an alternative random period of 1 hour and the numberOfRepeats element 1508 indicates that 2 additional file repair attempts may be made.

As illustrated in the example of FIG. 16, each of three (3) subsequent file repair requests may be made approximately 24 hours apart and each file repair request is made at a random time within a 1-hour period. In this way, if an initial file repair attempt made at a time corresponding to the end of the file delivery event is not successful, subsequent file repair requests may be made.

In one implementation, a single ADPD fragment extension 1502 may be included in a service announcement received by a UE as indicated by a single repeatPattern element 1516. In this implementation, a timeline for subsequent file repair attempts may be defined as fileSchedule.deliveryInfo@end or FDT@Expires+offsetTime+repeatIteration*repeatOffsetTime+rand[0, repeatRandomTimePeriod].

In an alternate implementation, multiple ADPD fragment extensions 1502 may be included in a service announcement received by a UE as indicated by multiple repeatPattern elements 1516. In this alternate implementation, a timeline for subsequent file repair attempts may be defined as fileSchedule.deliveryInfo@end or FDT@Expires+offsetTime+repeatIteration*repeatOffsetTime[i]+rand[0, repeatRandomTimePeriod[i]] where i represents each ADPD fragment extension 1502.

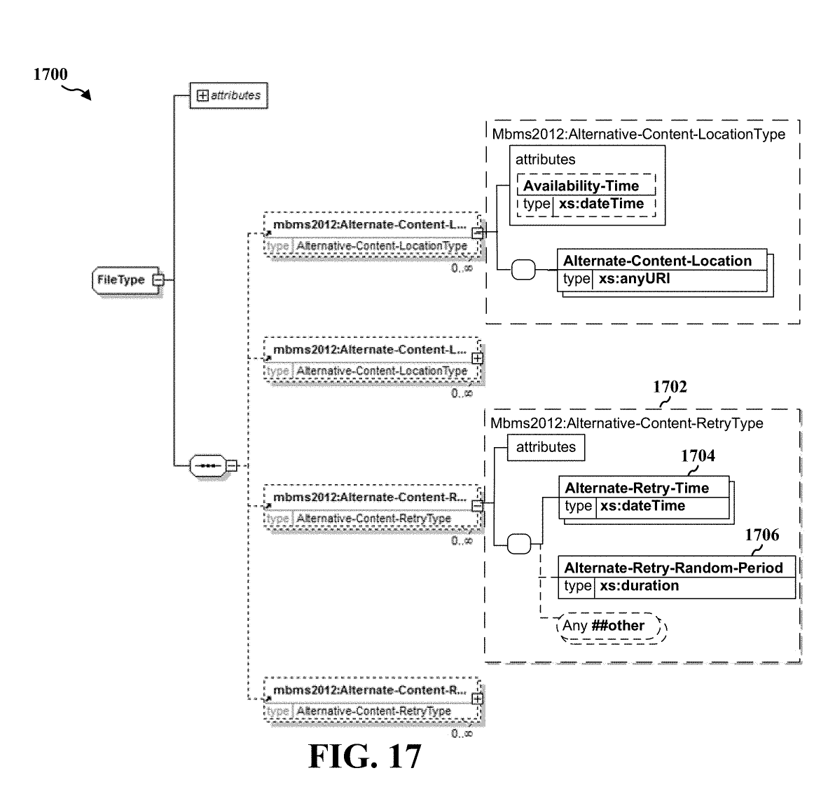

FIG. 17 is a graphical illustration 1700 of the XML schema of a FDT fragment extension 1702 that defines one or more additional windows for file repair corresponding to a first alternate content location according to some embodiments. Although only one FDT fragment extension corresponding to one alternative content location is shown in FIG. 17, a second FDT fragment extension corresponding to a second alternative content location may also be included in the FDT. The FDT fragment extension 1702 may be included in an FDT received over broadcast or an FDT downloaded from the FDTLocationURL 1002 in the schedule description fragment. Based on information included in the FDT fragment extension 1702, the UE may be able to determine additional window(s) within which request for file repair information may be performed. The FDT fragment extension 1702 includes, for example, an Alternate-Retry-Time element 1704 and an Alternate-Retry-Random-Period element 1706. Although not explicitly depicted, the service announcement may also include a FDT fragment extension corresponding to a second alternate content location.

The Alternate-Retry-Time element 1704 provides, for example, an anchor start time for new repair windows when additional byte-range file repair may be attempted using a URL provided by a corresponding Alternate-Content-Location in the FDT fragment. The Alternate-Retry-Random-Period element 1706 provides, for example, an alternative random period during which scheduling of additional file repair iterations are randomized.

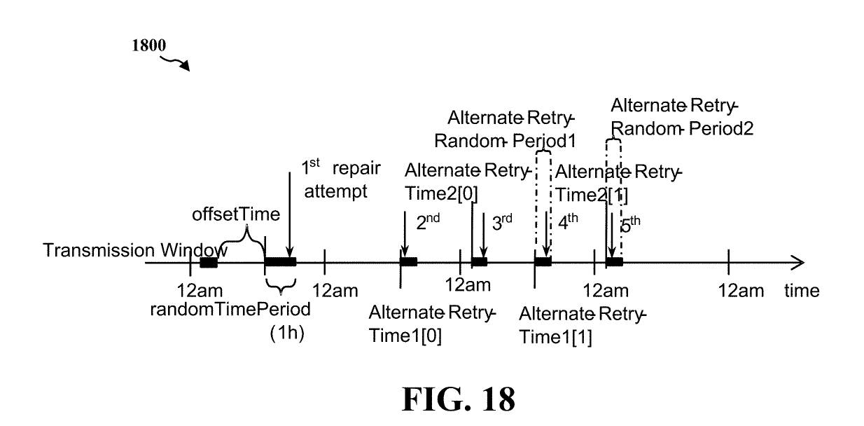

FIG. 18 illustrates an example of a timeline 1800 for file repair based on the FDT fragment extension 1702. In the illustrated example, an initial transmission window occurs shortly after 12 AM. That is, in the illustrated example files are scheduled for delivery via eMBMS broadcast after 12 AM. In this example, an initial offset time and randomTimePeriod are defined. As illustrated, an initial file repair based on Alternate-Content-Location-1 can be attempted at a first alternate retry time defined by Alternate-Retry-Time element 1704 during a random period defined by Alternate-Retry-Random-Period element 1706. Subsequently, an initial file repair based on Alternate-Content-Location-2 can be attempted at a second alternate retry time during a random period. Additional file repair attempts can be made alternatively for Alternate-Content-Location-1 and Alternate-Content-Location-2. In this way, if an initial file repair attempt made at a time corresponding to the end of the file delivery event is not successful, subsequent file repair requests may be made.

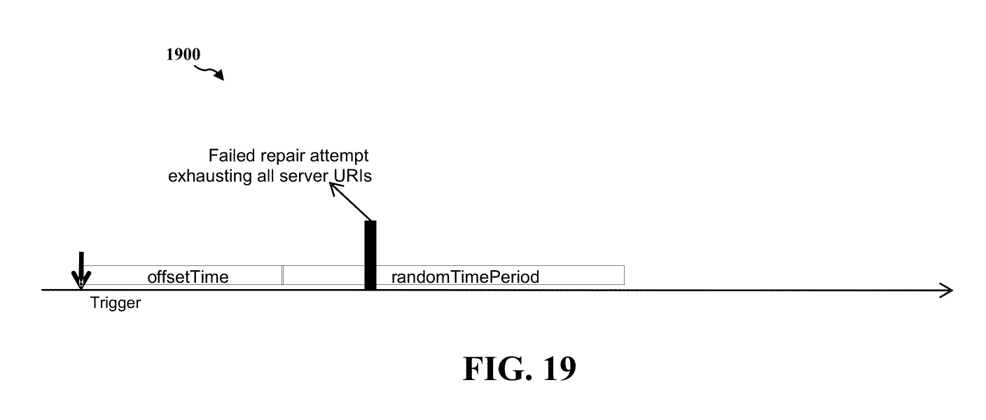

FIG. 19 illustrates an example of a general timeline 1900 for file repair based on the currently defined file repair attempt when fragment extensions 1402 or 1602 of the various embodiments are not available. In the various embodiments, if file repair requests to all corresponding server URIs failed with either HTTPClientTimeout or other HTTP errors, e.g., 400-417 or 500-505, then a UE will not retry file repair. Instead, additional file repair attempts can be made based on the timelines depicted in FIGS. 14, 16 and/or 18 according to various embodiments. In particular, if an ADPD fragment extension 1302 is included in a service announcement, the timeline depicted in FIG. 14 may be followed. If an ADPD fragment extension 1502 is included in the service announcement, the timeline depicted in FIG. 16 may be followed. If a FDT fragment extension 1702 is included in the service announcement, the timeline depicted in FIG. 18 may be followed. If both an ADPD fragment extension 1302, 1502 and a FDT fragment extension 1702 are included in the service announcement, both timelines (e.g., one timeline based on the ADPD fragment extension and one timeline based on the FDT fragment extension) may be followed.

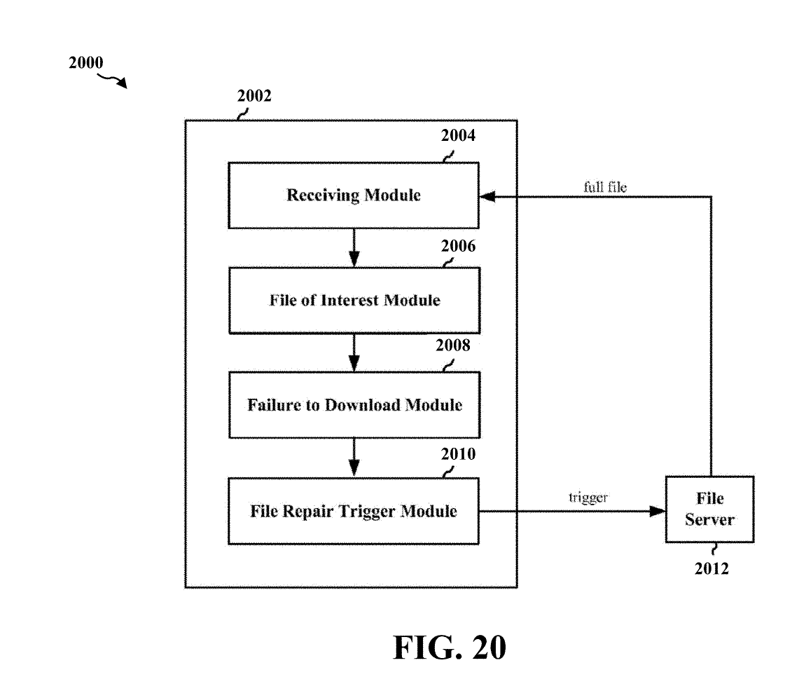

FIG. 20 is a conceptual data flow diagram 2000 illustrating the data flow between different modules or components in an exemplary receiver device 2002. The receiver device 2002 may be a UE. The receiver device 2002 includes a receiving module 2004 that receives file information (e.g., schedule description, session schedule, file schedule) from a server 2012 corresponding to files transmitted within a service, a file-of-interest module 2006 that determines that a file of interest is transmitted within a service, a failure-to-download 2008 that determines a failure to download the file of interest, and a file repair trigger module 2010 that triggers a repair of a file delivery event, wherein the time is derived from an information element included in the schedule description.

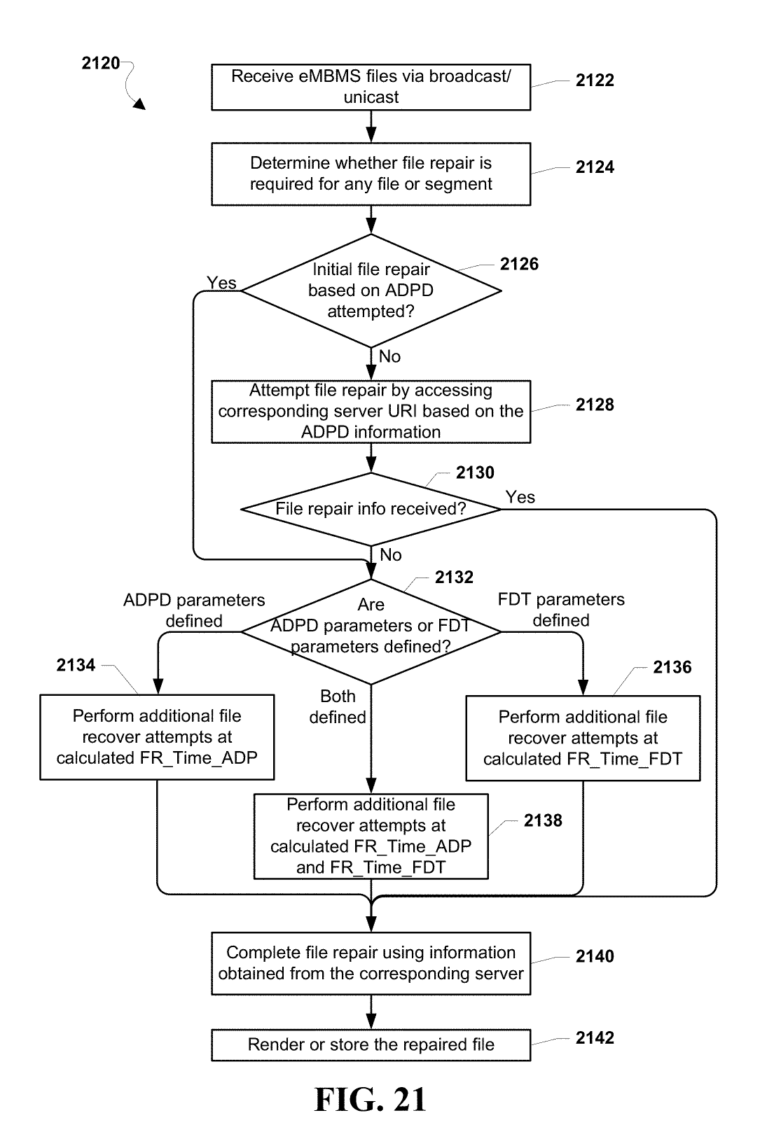

FIG. 21 illustrates a method 2120 of accomplishing file delivery repair according to various embodiments. Operations within the method 2120 may be performed by a UE (e.g., 102, 650) processor executing MSDC 132 functionality.

In block 2122, the UE may receive eMBMS files via a broadcast or determine that it has missed a broadcast transmission as described above.

In block 2124, the processor may determine whether file repair is required for any file or segment of a file or session. This may involve determining whether portions of the file were not received, were not able to be recovered using error correction coding within the received file, or none of the file has been received (missed broadcast).

If the processor determines that file repair is required, the processor may determine whether an initial file repair attempt per the current set of ADPD parameters has already been made in determination block 2126. For example, the processor may determine whether an initial file repair attempt has been made based on the ADPD information.

In response to determining that the initial file repair attempt specified in the schedule description has not been made (i.e., determination block 2126=“No”), the processor may attempt file repair at a backup time for receiving the file by accessing the corresponding server URI based on information in the ADPD fragment.

In determination block 2130, the processor may determine whether a file repair was successful. For example, the processor may determine whether it received any HTTP errors (e.g., 400-417 or 500-505) in response to the file repair attempt in block 2128.

In response to determining that file repair information was not received from the corresponding server URI (i.e., determination block 2130=“No”), or in response to determining that the initial file repair attempt specified in the schedule description has already been made (i.e., determination block 2126=“Yes”), the processor may determine whether the schedule description information defines ADPD parameters or FDT parameters as described in the file schemas illustrated in FIG. 13, 15, or 17.

In response to determining that the schedule description information defines ADPD parameters but not FDT parameters, the processor may perform additional file recovery attempts at times calculated based on a repair window start time, a repeat or iteration counter, and a repair window repeat interval plus a random back off time in block 2134. For example, the processor may calculate times for additional file recovery attempts according to the formula:

FR_Time_ADP=repairWindowStart+(repeatIteration+i)*repairWindowRepeateInterval+rand[0,repairWindowRandomPeriod] Eq. 1

where:
0<=i<=numberOfRepairTimes−1, or
0<=i while repairWindowStart+(repeatIteration+i)*repairWindowRepeateInterval<stopRepairInterval

In response to determining that the schedule description information defines FDT parameters but not ADPD parameters, the processor may perform additional file recovery attempts at times calculated based on an alternate retry time specified in the schedule description plus a random back off time in block 2136. For example, the processor may calculate times for additional file recovery attempts according to the formula:

FR_Time FDT[k]=Alternate-Retry-Time1/2[k]+rand[0, Alternate-Retry-Random-Period1/2] Eq. 2

In response to determining that the schedule description information defines FDT parameters but not ADPD parameters, the processor may perform additional file recovery attempts at times based upon both a repair window start time, a repeat or iteration counter, and a repair window repeat interval an alternate retry time defined in the schedule description (plus a random back off time) in block 2138. In other words, the processor may perform additional file recovery attempts at times calculated based upon equations 1 and 2.

In response to determining that file repair information was received from the corresponding URI (i.e., determination block 2130=“Yes”) or after performing additional file recovery attempts in any of blocks 2134, 2136 or 2138, the processor may complete the file repair using the file repair information obtained from the corresponding server in block 2140, and render or store the repaired file in block 2142.

The receiver device may include additional modules that perform each of the steps of the algorithm in the aforementioned flow charts. As such, each step in the aforementioned flow charts may be performed by a module and the receiver device may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

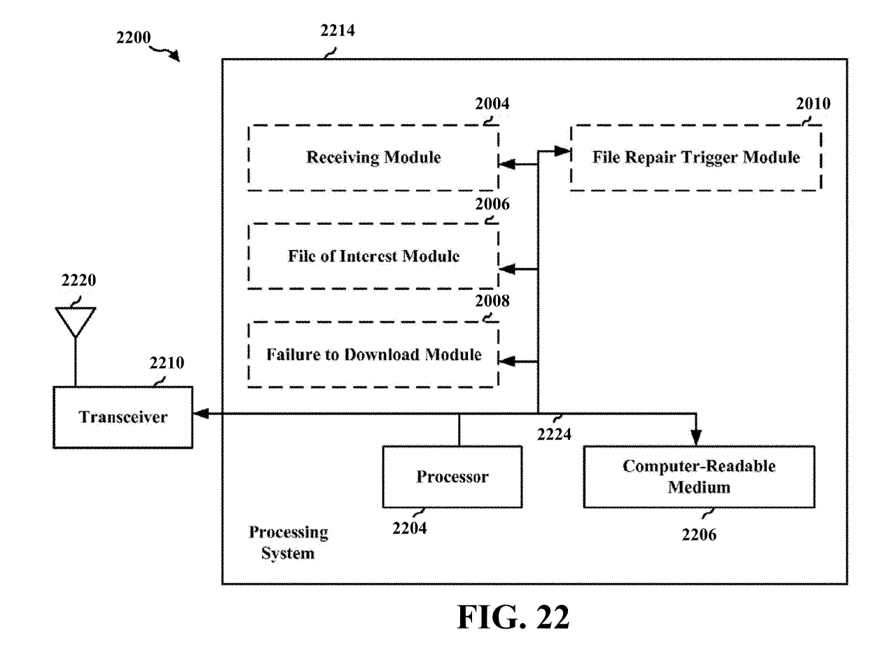

FIG. 22 is a diagram 2200 illustrating an example of a hardware implementation for a receiver device 2200 employing a processing system 2214. The processing system 2214 may be implemented with a bus architecture, represented generally by the bus 2224. The bus 2224 may include any number of interconnecting buses and bridges depending on the specific application of the processing system 2214 and the over-all design constraints. The bus 2324 links together various circuits including one or more processor 2204, the modules 2004, 2006, 2008, 2010 and the computer-readable medium 2206. The bus 2224 may also link various other circuits such as timing sources, peripherals, voltage regulators, and power management circuits, which are well known in the art, and therefore, will not be described any further.

The processing system 2214 may be coupled to a transceiver 2210. The transceiver 2210 is coupled to one or more antennas 2220. The transceiver 2210 receives a signal from the one or more antennas 2220, extracts information from the received signal, and provides the extracted information to the processing system 2214. In addition, the transceiver 2210 receives information from the processing system 2214, and based on the received information, generates a signal to be applied to the one or more antennas 2220. The processing system 2214 includes a processor 2204 coupled to a computer-readable medium 2206. The software, when executed by the processor 2204, causes the processing system 2214 to perform the various functions of the various embodiments. The computer-readable medium 2206 may also be used for storing data that is manipulated by the processor 2204 when executing software. The processing system further includes at least one of the modules 2004, 2006, 2008 and 2010. The modules may be software modules running in the processing 2204, resident/stored in the computer-readable medium 2206, one or more hardware modules coupled to the processor 2204, or some combination thereof. The processing system 2214 may be a component of the UE 102, 650 and may include the memory 660 and/or at least one of the TX processor 668, the RX processor 656, and the controller/processor 659 as described with reference to FIG. 6.

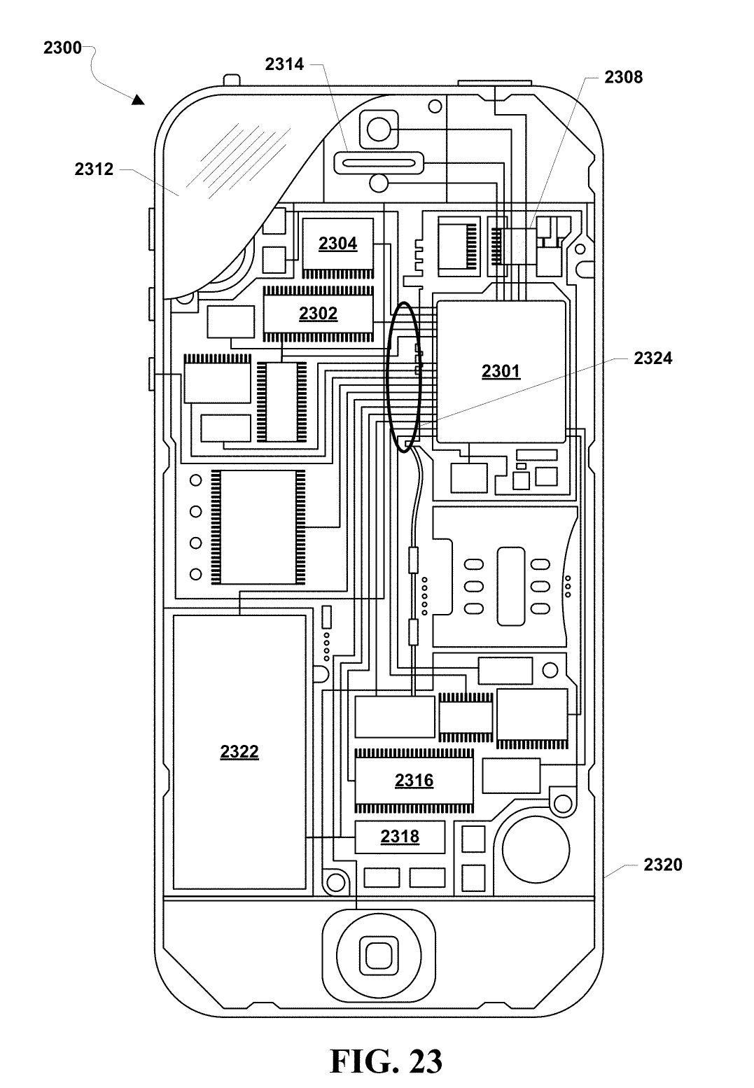

The various embodiments (including, but not limited to, embodiments discussed above with reference to FIGS. 1A-22) may be implemented in any of a variety of mobile devices (i.e., receiver devices), an example of which is illustrated in FIG. 23. For example, the mobile device 2300 may include a processor 2301 coupled to a touch screen controller 2304 and an internal memory 2302. The processor 2301 may be one or more multicore integrated circuits (ICs) designated for general or specific processing tasks. The internal memory 2302 may be volatile or non-volatile memory, and may also be secure and/or encrypted memory, or unsecure and/or unencrypted memory, or any combination thereof. The touch screen controller 2304 and the processor 2301 may also be coupled to a touch screen panel 2312, such as a resistive-sensing touch screen, capacitive-sensing touch screen, infrared sensing touch screen, etc.

The mobile computing device 2300 may have one or more radio signal transceivers 2308 (e.g., Peanut®, Bluetooth®, Zigbee®, Wi-Fi, RF, cellular, etc.) and antennae 2310, for sending and receiving, coupled to each other and/or to the processor 2301. The transceivers 2308 and antennae 2310 may be used with the above-mentioned circuitry to implement the various wireless transmission protocol stacks and interfaces. The mobile computing device 2300 may include a cellular network wireless modem chip 2316 that enables communication via a cellular network and is coupled to the processor.

The mobile computing device 2300 may include a peripheral device connection interface 2318 coupled to the processor 2301. The peripheral device connection interface 2318 may be singularly configured to accept one type of connection, or multiply configured to accept various types of physical and communication connections, common or proprietary, such as USB, FireWire, Thunderbolt, or PCIe. The peripheral device connection interface 2318 may also be coupled to a similarly configured peripheral device connection port (not shown).

The mobile computing device 2300 may also include speakers 2314 for providing audio outputs. The mobile computing device 2300 may also include a housing 2320, constructed of a plastic, metal, or a combination of materials, for containing all or some of the components discussed herein. The mobile computing device 2300 may include a power source 2322 coupled to the processor 2301, such as a disposable or rechargeable battery. The rechargeable battery may also be coupled to the peripheral device connection port to receive a charging current from a source external to the mobile computing device 2300.

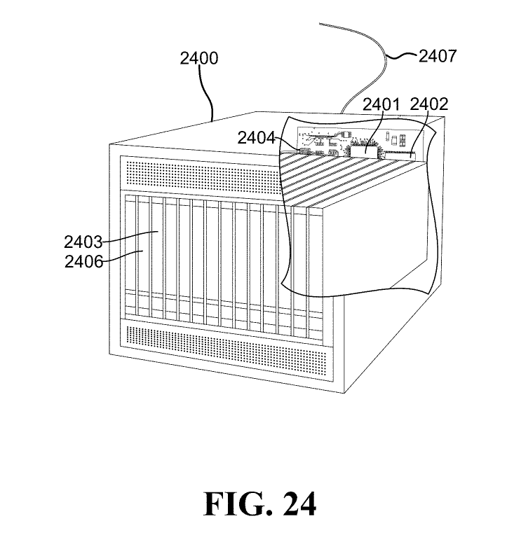

The various embodiments (including, but not limited to, embodiments discussed above with reference to FIGS. 1A-22) may also be implemented on any of a variety of commercially available server devices, such as the server 2400 illustrated in FIG. 24. Such a server 2400 typically includes a processor 2401 coupled to volatile memory 2402 and a large capacity nonvolatile memory, such as a disk drive 2404. The server 2400 may also include a floppy disc drive, compact disc (CD) or DVD disc drive 2406 coupled to the processor 2401. The server 2400 may also include one or more network transceivers 2403, such as a network access port, coupled to the processor 2401 for establishing network interface connections with a communication network 2407, such as a local area network coupled to other announcement system computers and servers, the Internet, the public switched telephone network, and/or a cellular network (e.g., CDMA, TDMA, GSM, PCS, 3G, 4G, LTE, or any other type of cellular network).

The processors 2301 and 2401 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 2401 and 2401. The processors 2301 and 2401 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 2301 and 2401 including internal memory or removable memory plugged into the device and memory within the processors 2301 and 2401 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more processor-executable instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to some embodiments without departing from the scope of the claims. Thus, the claims are not intended to be limited to the embodiments shown herein but are to be accorded the widest scope consistent with the language of the claims and the principles and novel features disclosed herein.

What is claimed is:

1. A method for receiving a file by a user equipment, comprising:
determining whether a file repair procedure of the file was successfully performed during a first window of time specified in a broadcast schedule description; and
in response to determining that the file repair procedure of the file was not successfully performed during the first window of time:
determining a second window of time for attempting an additional file repair procedure based on an Associated Delivery Procedure Description (ADPD) fragment in the broadcast schedule description or a File Delivery Template (FDT) fragment in the broadcast schedule description; and
attempting the file repair procedure during the determined second window of time.

2. The method of claim 1, wherein determining a second window of time for attempting an additional file repair procedure based on an ADPD fragment in the broadcast schedule description or a FDT fragment in the broadcast schedule description comprises:
determining a second window of time for attempting file repair procedure based on an ADPD fragment in the broadcast schedule description, the ADPD fragment comprising:
a window start attribute;
a random period attribute;
a repeat interval attribute;
a stop interval attribute; and
a number of times attribute.

3. The method of claim 2, wherein attempting the file repair procedure during the determined second window of time comprises attempting the file repair procedure at a time based on:
the window start attribute;
the repeat interval attribute; and
a random offset amount of time based on the random period attribute.

4. The method of claim 2, further comprising:
determining whether the file repair procedure during the determined second window of time was successful; and
in response to determining that the file repair procedure during the determined second window of time was not successful:
determining a third window of time for attempting an additional file repair procedure based on the repeat interval attribute and the stop interval attribute in the ADPD fragment; and
attempting the file repair procedure during the determined third window of time.

5. The method of claim 1, wherein determining a second window of time for attempting an additional file repair procedure based on an ADPD fragment in the broadcast schedule description or a FDT fragment in the broadcast schedule description comprises:
determining a second window of time for attempting file repair procedure based on an ADPD fragment in the broadcast schedule description, the ADPD fragment comprising:
an offset time attribute;
a random time period attribute; and
a number of times attributes.

6. The method of claim 5, wherein attempting the file repair procedure during the determined second window of time comprises attempting the file repair procedure at a time based on the offset time attribute offset by a random amount of time based on the random time period attribute.

7. The method of claim 5, further comprising:
determining whether the file repair procedure during the determined second window of time was successful; and
in response to determining that the file repair procedure during the determined second window of time was not successful:
determining a third window of time for attempting an additional file repair procedure based on the offset time attribute and a random amount of time based on the random time period attribute.

8. The method of claim 1, wherein determining a second window of time for attempting an additional file repair procedure based on an ADPD fragment in the broadcast schedule description or a FDT fragment in the broadcast schedule description comprises:
determining a second window of time for attempting file repair procedure based on a FDT fragment in the broadcast schedule description, the FDT fragment comprising:
a retry time attribute; and
a random period attribute.

9. The method of claim 8, wherein attempting the file repair procedure during the determined second window of time comprises attempting the file repair procedure at a time indicated by the retry time attribute and a random offset amount of time based on the random period attribute.

10. The method of claim 9, further comprising repeatedly attempting the file repair procedure during intervals of time defined by the retry time attribute and a random offset amount of time based on the random period attribute until the file repair procedure is successful.

11. A user equipment for wireless communication, comprising:
a memory; and
a processor coupled to the memory and configured with processor executable instructions to perform operations comprising:
determining whether a file repair procedure of the file was successfully performed during a first window of time specified in a broadcast schedule description; and
in response to determining that the file repair procedure of a file was not successfully performed during the first window of time:
determining a second window of time for attempting an additional file repair procedure based on an Associated Delivery Procedure Description (ADPD) fragment in the broadcast schedule description or a File Delivery Template (FDT) fragment in the broadcast schedule description; and
attempting the file repair procedure during the determined second window of time.

12. The user equipment of claim 11, wherein the processor is configured with processor executable instructions to perform operations such that determining a second window of time for attempting an additional file repair procedure based on an ADPD fragment in the broadcast schedule description or a FDT fragment in the broadcast schedule description comprises:
determining a second window of time for attempting file repair procedure based on an ADPD fragment in the broadcast schedule description, the ADPD fragment comprising:
a window start attribute;
a random period attribute;
a repeat interval attribute;
a stop interval attribute; and
a number of times attribute.

13. The user equipment of claim 12, wherein the processor is configured with processor executable instructions to perform operations such that attempting the file repair procedure during the determined second window of time comprises attempting the file repair procedure at a time based on:
the window start attribute;
the repeat interval attribute; and
a random offset amount of time based on the random period attribute.

14. The user equipment of claim 12, wherein the processor is configured with processor executable instructions to perform operations further comprising:
determining whether the file repair procedure during the determined second window of time was successful; and
in response to determining that the file repair procedure during the determined second window of time was not successful:
determining a third window of time for attempting an additional file repair procedure based on the repeat interval attribute and the stop interval attribute in the ADPD fragment; and
attempting the file repair procedure during the determined third window of time.

15. The user equipment of claim 12, wherein the processor is configured with processor executable instructions to perform operations further comprising repeatedly attempting the file repair procedure during intervals of time defined by the repeat interval attribute and the stop interval attribute in the ADPD fragment until a number of requests for the file equals a number indicated by the number of times attribute or the file repair procedure is successful.

16. The user equipment of claim 11, wherein the processor is configured with processor executable instructions to perform operations such that determining a second window of time for attempting an additional file repair procedure based on an ADPD fragment in the broadcast schedule description or a FDT fragment in the broadcast schedule description comprises:
determining a second window of time for attempting file repair procedure based on an ADPD fragment in the broadcast schedule description, the ADPD fragment comprising:
an offset time attribute;
a random time period attribute; and
a number of times attribute.

17. The user equipment of claim 16, wherein the processor is configured with processor executable instructions to perform operations such that attempting the file repair procedure during the determined second window of time comprises attempting the file repair procedure at a time based on the offset time attribute offset by a random amount of time based on the random time period attribute.

18. The user equipment of claim 16, wherein the processor is configured with executable instructions to perform operations further comprising:
determining whether the file repair procedure during the determined second window of time was successful; and
in response to determining that the file repair procedure during the determined second window of time was not successful:
determining a third window of time for attempting an additional file repair procedure based on the offset time attribute and a random amount of time based on the random time period attribute.

19. The user equipment of claim 16, wherein the processor is configured with processor executable instructions to perform operations further comprising repeatedly attempting the file repair procedure during intervals of time defined by the offset time attribute until a number of requests for the file equals a number indicated by the number of times attribute or the file repair procedure is successful.

20. The user equipment of claim 11, wherein the processor is configured with processor executable instructions to perform operations such that determining a second window of time for attempting an additional file repair procedure based on an ADPD fragment in the broadcast schedule description or a FDT fragment in the broadcast schedule description comprises:
determining a second window of time for attempting file repair procedure based on a FDT fragment in the broadcast schedule description, the FDT fragment comprising:
a retry time attribute; and
a random period attribute.

21. The user equipment of claim 20, wherein the processor is configured with processor executable instructions to perform operations such that attempting the file repair procedure during the determined second window of time comprises attempting the file repair procedure at a time indicated by the retry time attribute and a random offset amount of time based on the random period attribute.

22. The user equipment of claim 20, wherein the processor is configured with processor executable instructions to perform further operations comprising repeatedly attempting the file repair procedure during intervals of time defined by the retry time attribute and a random offset amount of time based on the random period attribute until the file repair procedure is successful.

23. A user equipment for wireless communication, comprising:
means for determining whether a file repair procedure of a file was successfully performed during a first window of time specified in a broadcast schedule description; and
means for determining a second window of time for attempting an additional file repair procedure based on an Associated Delivery Procedure Description (ADPD) fragment in the broadcast schedule description or a File Delivery Template (FDT) fragment in the broadcast schedule description in response to determining that the file repair procedure of the file was not successfully performed during the first window of time; and
means for attempting the file repair procedure during the determined second window of time.

24. The user equipment of claim 23, wherein means for determining a second window of time for attempting an additional file repair procedure based on an ADPD fragment in the broadcast schedule description or a FDT fragment in the broadcast schedule description comprises:
means for determining a second window of time for attempting file repair procedure based on an ADPD fragment in the broadcast schedule description, the ADPD fragment comprising:
a window start attribute;
a random period attribute;
a repeat interval attribute;
a stop interval attribute; and
a number of times attribute.

25. The user equipment of claim 23, wherein means for determining a second window of time for attempting an additional file repair procedure based on an ADPD fragment in the broadcast schedule description or a FDT fragment in the broadcast schedule description comprises:
means for determining a second window of time for attempting file repair procedure based on an ADPD fragment in the broadcast schedule description, the ADPD fragment comprising:
an offset time attribute;
a random time period attribute; and
a number of times attributes.

26. The user equipment of claim 23, wherein means for determining a second window of time for attempting an additional file repair procedure based on an ADPD fragment in the broadcast schedule description or a FDT fragment in the broadcast schedule description comprises:
means for determining a second window of time for attempting file repair procedure based on a FDT fragment in the broadcast schedule description, the FDT fragment comprising:
a retry time attribute; and
a random period attribute.

27. A non-transitory processor-readable medium having stored thereon processor executable instructions configured to cause a processor of a user equipment to perform operations comprising:
determining whether a file repair procedure of a file was successfully performed during a first window of time specified in a broadcast schedule description; and
in response to determining that the file repair procedure of the file was not successfully performed during the first window of time:
determining a second window of time for attempting an additional file repair procedure based on an Associated Delivery Procedure Description (ADPD) fragment in the broadcast schedule description or a File Delivery Template (FDT) fragment in the broadcast schedule description; and
attempting the file repair procedure during the determined second window of time.

28. The non-transitory processor-readable medium of claim 27, wherein the stored processor executable instructions are configured to cause a processor of a user equipment to perform operations such that determining a second window of time for attempting an additional file repair procedure based on an ADPD fragment in the broadcast schedule description or a FDT fragment in the broadcast schedule description comprises:
determining a second window of time for attempting file repair procedure based on an ADPD fragment in the broadcast schedule description, the ADPD fragment comprising:
a window start attribute;
a random period attribute;
a repeat interval attribute;
a stop interval attribute; and
a number of times attribute.

29. The non-transitory processor-readable medium of claim 27, wherein the stored processor executable instructions are configured to cause a processor of a user equipment to perform operations such that determining a second window of time for attempting an additional file repair procedure based on an ADPD fragment in the broadcast schedule description or a FDT fragment in the broadcast schedule description comprises:
determining a second window of time for attempting file repair procedure based on an ADPD fragment in the broadcast schedule description, the ADPD fragment comprising:
an offset time attribute;
a random time period attribute; and
a number of times attributes.

30. The non-transitory processor-readable medium of claim 27, wherein the stored processor executable instructions are configured to cause a processor of a user equipment to perform operations such that determining a second window of time for attempting an additional file repair procedure based on an ADPD fragment in the broadcast schedule description or a FDT fragment in the broadcast schedule description comprises:
determining a second window of time for attempting file repair procedure based on a FDT fragment in the broadcast schedule description, the FDT fragment comprising:
a retry time attribute; and
a random period attribute.
